(19) United States
(12) Patent Application Publication
(10) Pub. No.: US 2026/0019471 A1
(43) Pub. Date: Jan. 15, 2026

(54) COMMUNICATION METHOD, COMMUNICATION APPARATUS, COMPUTER-READABLE STORAGE MEDIUM, AND PROGRAM PRODUCT

(71) Applicant: HUAWEI TECHNOLOGIES CO., LTD., Shenzhen (CN)

(72) Inventors: Yao Xiao, Shenzhen (CN); Zihan Tang, Shenzhen (CN); Mengyao Ma, Shenzhen (CN); Junwen Xie, Wuhan (CN); Ying Li, Shenzhen (CN)

(73) Assignee: HUAWEI TECHNOLOGIES CO., LTD., Shenzhen (CN)

(21) Appl. No.: 19/336,513

(22) Filed: Sep. 23, 2025

Related U.S. Application Data
(63) Continuation of application No. PCT/CN2023/097554, filed on May 31, 2023.

(51) Int. Cl. H04L 69/04; G06T 9/00

(52) U.S. Cl. CPC H04L 69/04; G06T 9/00

(57) ABSTRACT

Embodiments of this disclosure provide a communication method and apparatus, a computer-readable storage medium, and a computer program product. In the method, a topological feature is extracted from point cloud data; the point cloud data is compressed based on the topological feature, to obtain compressed data of the point cloud data; and the compressed data is output. In this way, embodiments of this disclosure can reduce a data amount of reporting the point cloud data in a sensing scenario.

### CROSS-REFERENCE TO RELATED APPLICATIONS

This application is a continuation of International Application No. PCT/CN2023/097554, filed on May 31, 2023, the disclosure of which is hereby incorporated by reference in its entirety.

### TECHNICAL FIELD

This disclosure generally relates to the telecommunication field, and more specifically, to a communication method, a communication apparatus, a computer-readable storage medium, and a computer program product.

### BACKGROUND

Point cloud data may be used in a plurality of application scenarios such as 3D imaging, environment reconstruction, and target recognition, and is an important form of native data in future communication sensing scenarios. When a single terminal device senses an ambient environment, only a local point cloud signal can be obtained due to a limited angle and location. To perform subsequent tasks such as environment reconstruction and target recognition, global information usually needs to be obtained. To obtain global information by using a single device, the single device needs to change an angle and a location to perform a plurality of times of sensing. A plurality of devices are used to jointly sense an ambient environment from different angles and at different locations, so that sensing overheads of a single terminal device can be reduced, and a focused observation region is adjusted based on a location of each device, to obtain local sensing information with higher precision. In a multi-device joint sensing scenario, point cloud information sensed by terminal devices from a plurality of angles and at a plurality of locations all needs to be sent to a base station for information fusion.

### SUMMARY

This disclosure provides a communication method, a communication apparatus, a computer-readable storage medium, and a computer program product, to reduce a data amount of reporting point cloud data in a sensing scenario.

According to a first aspect, a communication method is provided. The method is executed by a first communication apparatus, which may be, for example, a terminal device or a chip used in the terminal device. In the method, at the first communication apparatus, a topological feature is extracted from point cloud data; the point cloud data is compressed based on the topological feature, to obtain compressed data of the point cloud data; and the compressed data is output. In this manner, a data amount of reporting the point cloud data can be reduced.

In some implementations, extracting the topological feature from the point cloud data includes: obtaining persistent homology of values of the point cloud data; and obtaining first value information based on values that are of the point cloud data and whose persistent homology meets a preset condition, where the first value information is used to express the topological feature. In this way, the point cloud data is compressed, and the data amount of reporting the point cloud data is reduced.

In some implementations, a persistent diagram is generated based on the point cloud data, where the persistent diagram is used to obtain the persistent homology of the values of the point cloud data. In this way, obtaining efficiency of obtaining the persistent homology can be improved.

In some implementations, compressing the point cloud data includes: generating the compressed data based on the first value information and first location vector information corresponding to the first value information, where the first location vector information includes indication information for a location corresponding to the first value information in the point cloud data. This manner helps a receive end of the point cloud data accurately restore the point cloud data.

In some implementations, the first value information is associated with a first part of the point cloud data, the compressed data further includes second location vector information associated with a second part of the point cloud data, and the second location vector information includes indication information for a location, in the point cloud data, corresponding to second value information associated with the second part of the point cloud data. In this way, a data amount of reporting a point cloud data is reported is reduced, and accuracy of restoring an original point cloud data based on the compressed data by a party that receives the point cloud data can be improved.

In some implementations, the first part of the point cloud data and the second part of the point cloud data form the point cloud data. Because the compressed data is obtained based on components of the point cloud data, the party that receives the point cloud can restore the point cloud data more accurately.

In some implementations, selecting the values that are of the point cloud data and whose persistent homology meets the preset condition includes: receiving a topology information configuration, where the topology information configuration indicates a ratio at which the topological feature is retained; and selecting, based on the ratio, a plurality of values with largest persistent homology that are in the values of the point cloud data and whose quantity of the values meets the ratio. In this manner, the topological feature is extracted based on a configuration, and the receive end of the point cloud data can accurately restore the point cloud data.

In some implementations, obtaining the persistent homology includes: converting the point cloud data into a two-dimensional point cloud matrix, where elements in the two-dimensional point cloud matrix correspond to the values of the point cloud data; and obtaining the persistent homology based on element values and element locations in the two-dimensional point cloud matrix. In this manner, extraction of the topological feature is facilitated.

In some implementations, obtaining the persistent homology includes: generating a point cloud data vector based on the element values and the element locations in the two-dimensional point cloud matrix; and obtaining the persistent homology based on the values of the point cloud data and locations corresponding to the values of the point cloud data in the point cloud data vector. Therefore, extraction of the topological feature can be facilitated.

In some implementations, the indication information in the first location vector information indicates a corresponding location of the first value information in the point cloud data vector. Therefore, overall information of the point cloud data can be transferred and data compression can be implemented.

In some implementations, the method further includes one of the following: obtaining a preset coordinate indication mode configuration; generating the coordinate indication mode configuration, and sending the coordinate indication mode configuration; or receiving the coordinate indication mode configuration, where the coordinate indication mode configuration indicates an arrangement order that is of the values of the point cloud data and that is used when the two-dimensional point cloud matrix is used to generate the point cloud data vector.

In some implementations, the method further includes: sending or receiving a quantization configuration, where the quantization configuration indicates a manner of quantizing coordinate values of the point cloud data, and quantized Z-axis coordinate values of the point cloud data in a three-dimensional coordinate system are the element values in the two-dimensional point cloud matrix. Quantization configuration may be performed on a side of either a sending party or a receiving party of the point cloud data, and a configuration manner is flexible.

In some implementations, the three-dimensional coordinate system is a three-dimensional global coordinate system, and the method further includes: sending or receiving a conversion mode configuration, where the conversion mode configuration indicates whether to perform coordinate system mapping from the three-dimensional global coordinate system to a three-dimensional local coordinate system on the point cloud data. In this manner, whether to perform coordinate system mapping may be determined based on a configuration, and an implementation manner is flexible.

In some implementations, the point cloud data corresponds to one clustering plane, and the method according to the first aspect further includes: clustering, based on distances from points, in a point cloud, corresponding to data in an input point cloud data set to one or more clustering planes, the input point cloud data set, to obtain the point cloud data corresponding to the clustering plane, where the clustering plane corresponding to the point cloud data is a clustering plane with a shortest distance in the one or more clustering planes. Therefore, a geometric plane structure of the point cloud data can be fully utilized to segment the original point cloud data, so as to facilitate extraction of the topological feature and compression of the point cloud data.

In some implementations, the method further includes: sending a clustering configuration for clustering the input point cloud data set. In this way, the point cloud data is clustered in a configured manner.

In some implementations, determining the clustering plane includes: separately projecting the input point cloud data set based on planes of the three-dimensional coordinate system; obtaining a projected convex hull point set based on edge information of projections of the point cloud data in the planes of the three-dimensional coordinate system; and determining the clustering plane based on candidate planes including a plurality of points in the projected convex hull point set. In this way, the clustering plane for clustering the point cloud data is accurately selected.

In some implementations, determining the clustering plane includes: selecting, based on distribution of the input point cloud data set in the candidate planes, one or more candidate planes from the plurality of candidate planes including the plurality of points in the projected convex hull point set as the clustering plane. The clustering plane for clustering the point cloud data can be accurately selected.

In some implementations, the method further includes: obtaining preset first configuration information; generating the first configuration information, and sending the first configuration information; or receiving the first configuration information, where the first configuration information is used to configure at least one of the following: a compression manner configuration, indicating a manner of compressing the point cloud data; or an auxiliary information precision configuration, indicating at least one of a compression boundary for compressing the point cloud data and a quantity of bits of a mapping coordinate system. A configuration manner is flexible.

According to a second aspect, a communication method is provided. For beneficial effects, refer to the descriptions of the first aspect. Details are not described herein again. The method is executed by a second communication apparatus, which may be, for example, a network device or a chip used in the network device. In the method, compressed data of point cloud data is received, where the compressed data includes first value information and first location vector information that are associated with the point cloud data; and the point cloud data is obtained based on the first value information and the first location vector information.

In some implementations, the first value information and the first location vector information are associated with a first part of the point cloud data, the compressed data further includes second location vector information associated with a second part of the point cloud data, and obtaining the point cloud data includes: obtaining the point cloud data based on the first value information, the first location vector information, second value information, and the second location vector information, where the second value information is associated with the second part of the point cloud data, and is determined based on the first value information, the first location vector information, and the second location vector information.

In some implementations, determining the second value information includes: generating a point cloud data vector based on the first value information and the first location vector information; generating a function curve based on the point cloud data vector; and determining the second value information in the function curve based on the second location vector information.

In some implementations, obtaining the point cloud data includes: determining, based on an arrangement order, indicated in a coordinate indication mode configuration, of values of the point cloud data in a two-dimensional point cloud matrix in the point cloud data vector, a location set of the first value information and the second value information in the two-dimensional point cloud matrix; determining the two-dimensional point cloud matrix based on the location set; and determining the point cloud data based on element values and element locations in the two-dimensional point cloud matrix.

In some implementations, the method further includes one of the following: obtaining a preset coordinate indication mode configuration; generating the coordinate indication mode configuration, and sending the coordinate indication mode configuration; or receiving the coordinate indication mode configuration, where the coordinate indication mode configuration indicates the arrangement order of the values of the point cloud data in the two-dimensional point cloud matrix in the point cloud data vector.

In some implementations, obtaining the point cloud data includes: determining the point cloud data in a three-dimensional coordinate system based on the element values and the element locations in the two-dimensional point cloud matrix, where the element values in the two-dimensional point cloud matrix are quantized Z-axis coordinate values of the point cloud data in the three-dimensional coordinate system.

In some implementations, the three-dimensional coordinate system is a three-dimensional global coordinate system, and the method according to the second aspect further includes one of the following: obtaining a preset conversion mode configuration; generating the conversion mode configuration, and sending the conversion mode configuration; or receiving the conversion mode configuration, where the conversion mode configuration indicates whether coordinate system mapping from the three-dimensional global coordinate system to a three-dimensional local coordinate system is performed on the point cloud data.

In some implementations, the method further includes one of the following: obtaining a preset quantization configuration; generating the quantization configuration, and sending the quantization configuration; or receiving the quantization configuration, where the quantization configuration indicates a manner of quantizing coordinate values of the point cloud data, and the quantized coordinate values, after being dequantized, correspond to the Z-axis coordinate values of the point cloud data in the three-dimensional coordinate system.

In some implementations, the point cloud data corresponds to a clustering plane, and the method according to the second aspect further includes: receiving a clustering configuration for clustering an input point cloud data set, where the clustering configuration is used to obtain the input point cloud data set based on the point cloud data corresponding to each clustering plane.

In some implementations, the method further includes one of the following: obtaining preset first configuration information; generating the first configuration information, and sending the first configuration information; or receiving the first configuration information, where the first configuration information is used to configure at least one of the following: a compression manner configuration, indicating a manner of compressing the point cloud data; or an auxiliary information precision configuration, indicating at least one of a compression boundary for compressing the point cloud data and a quantity of bits of a mapping coordinate system.

In some implementations, the method further includes: sending a topology information configuration, where the topology information configuration indicates a ratio at which a topological feature is retained, and the topological feature is used to determine the first value information associated with the first part of the point cloud data from the point cloud data.

According to a third aspect, a first communication apparatus is provided. For beneficial effects, refer to the descriptions of the first aspect. Details are not described herein again. The apparatus has functions of implementing actions in the method example in the first aspect. The functions may be implemented by hardware, or may be implemented by hardware executing corresponding software. The hardware or software includes one or more modules corresponding to the foregoing functions. In a possible design, the apparatus includes: an extraction unit, configured to extract a topological feature from point cloud data; a compression unit, configured to compress the point cloud data based on the topological feature, to obtain compressed data of the point cloud data; and a sending unit, configured to output the compressed data.

According to a fourth aspect, a second communication apparatus is provided. For beneficial effects, refer to the descriptions of the first aspect. Details are not described herein again. The apparatus has functions of implementing actions in the method example in the second aspect. The functions may be implemented by hardware, or may be implemented by hardware executing corresponding software. The hardware or software includes one or more modules corresponding to the foregoing functions. In a possible design, the apparatus includes: a receiving unit, configured to receive compressed data of point cloud data, where the compressed data includes first value information and first location vector information that are associated with the point cloud data; and a determining unit, configured to obtain the point cloud data based on the first value information and the first location vector information.

According to a fifth aspect, a communication apparatus is provided, including a processor and a memory storing instructions, where when the instructions are executed by the processor, any method according to the first aspect and the implementations of the first aspect is performed.

According to a sixth aspect, a communication apparatus is provided, including a processor and a memory storing instructions, where when the instructions are executed by the processor, any method according to the second aspect and the implementations of the second aspect is performed. According to a seventh aspect, a computer-readable storage medium is provided, where

the computer-readable storage medium stores instructions, and when the instructions are executed, the method performed by the first communication apparatus or the second communication apparatus in the foregoing aspects is performed.

According to an eighth aspect, a computer program product is provided, where the computer program product includes instructions, and when the instructions are executed by an electronic device, the method performed by or in the foregoing aspects is performed.

According to a ninth aspect, this disclosure provides a chip system. The chip system includes a processor, configured to implement the functions of or in the methods in the foregoing aspects. In a possible design, the chip system further includes a memory, configured to store program instructions and/or data. The chip system may include a chip, or may include a chip and another discrete component.

According to a tenth aspect, this disclosure further provides a communication system, including: a first communication apparatus configured to perform the method according to the first aspect, or a second communication apparatus configured to perform the method according to the second aspect.

### BRIEF DESCRIPTION OF DRAWINGS

FIG. 1A is a diagram of a communication system according to some embodiments of this disclosure;

FIG. 1B is a diagram of a point cloud data compression scenario according to some embodiments of this disclosure;

FIG. 2 is a diagram of a communication procedure according to some embodiments of this disclosure;

FIG. 3 is a diagram of a point cloud data compression procedure according to some embodiments of this disclosure; FIG. 4 is a diagram of an original point cloud according to some embodiments of this

disclosure;

FIG. 5A is a diagram of a projection of an original point cloud on a yz-plane according to some embodiments of this disclosure;

FIG. 5B is a diagram of edge information of a projection plane of an original point cloud on a yz-plane according to some embodiments of this disclosure;

FIG. 5C is a diagram of convex hulls of a projection plane of an original point cloud on a yz-plane according to some embodiments of this disclosure;

FIG. 6 is a diagram of filtering for a clustering plane according to some embodiments of this disclosure;

FIG. 7 is a schematic flowchart of filtering for a clustering plane according to some embodiments of this disclosure;

FIG. 8 is a diagram of a clustering plane according to some embodiments of this disclosure;

FIG. 9 is a diagram of a clustering plane of an original point cloud and a global coordinate system of the clustering plane according to some embodiments of this disclosure;

FIG. 10 is a diagram of a clustering plane of an original point cloud and the original point cloud mapped to a new coordinate system according to some embodiments of this disclosure;

FIG. 11 is a diagram of a 2D matrix A according to some embodiments of this disclosure;

FIG. 12 is a diagram of A^{ƒ} obtained through topological feature filtering performed on a matrix A according to some embodiments of this disclosure;

FIG. 13 is a diagram of topology information analysis of a one-dimensional function according to some embodiments of this disclosure;

FIG. 14 is a diagram of restoring and constructing a 2D matrix Ã in an interpolation manner according to some embodiments of this disclosure;

FIG. 15 is a diagram of comparison between an original point cloud and a restored point cloud according to some embodiments of this disclosure;

FIG. 16 is a diagram of a signaling transmission procedure according to some embodiments of this disclosure;

FIG. 17 is a diagram of comparison between simulation results and Draco according to some embodiments of this disclosure;

FIG. 18 is a diagram of a procedure implemented at a first communication apparatus according to some embodiments of this disclosure;

FIG. 19 is a diagram of a procedure implemented at a second communication apparatus according to some embodiments of this disclosure;

FIG. 20 is a diagram of main composition of an example device in a possible implementation according to an embodiment of this disclosure; and

FIG. 21 is a simplified block diagram of an example device in a possible implementation according to an embodiment of this disclosure.

### DESCRIPTION OF EMBODIMENTS

Embodiments of this disclosure are described in more detail below with reference to the accompanying drawings. Although some embodiments of this disclosure are shown in the accompanying drawings, it should be understood that this disclosure may be implemented in various forms, and should not be construed as being limited to embodiments described herein, and instead, these embodiments are provided for a more thorough and complete understanding of this disclosure. It should be understood that the accompanying drawings and embodiments of this disclosure are merely used as examples and are not intended to limit the protection scope of this disclosure.

In the descriptions of embodiments of this disclosure, the term “include” and similar terms thereof shall be understood as non-exclusive inclusions, that is, “include but not limited to”. The term “based on” should be understood as “at least partially based on”. The term “an embodiment” or “this embodiment” should be understood as “at least one embodiment”. The terms “first”, “second”, and the like may indicate different objects or a same object. Other explicit and implicit definitions may also be included below.

Embodiments of this disclosure may be implemented according to any proper communication protocol, including but not limited to cellular communication protocols such as 4th generation (4G), 5th generation (5G), and future (for example, 6th generation (6G)) communication protocols, a wireless local area network communication protocol like the institute of electrical and electronics engineers (IEEE) 802.11 (for example, Wi-Fi7 and Wi-Fi8), and/or any other protocol currently known or developed in the future.

Technical solutions in embodiments of this disclosure are applied to a communication

system that complies with any proper communication protocol, for example, a general packet radio service (GPRS), a global system for mobile communications (GSM) system, an enhanced data rate for GSM evolution (EDGE) system, a universal mobile telecommunications system (UMTS), a long term evolution (LTE) system, a wideband code division multiple access (WCDMA) system, a code division multiple access 2000 (CDMA2000) system, a time division-synchronous code division multiple access (TD-SCDMA) system, a frequency division duplex (FDD) system, a time division duplex (TDD) system, a 5th generation (5G) system (for example, new radio (NR)), a future communication system (for example, a 6th generation (6G) system), and the like. Specifically, the technical solutions in embodiments of this disclosure may be used in any network in which a pre-scheduling mode exists.

For the purpose of illustration, the following describes embodiments of this disclosure in a background of a 5G communication system in 3GPP. However, it should be understood that embodiments of this disclosure are not limited to the communication system, but may be applied to any communication system having a similar problem, for example, a wireless local area network (WLAN), a wired communication system, or another communication system developed in the future.

The term “terminal” or “terminal device” used in this disclosure refers to any terminal device that can perform wired or wireless communication with a network device or any terminal devices that can perform wired or wireless communication with each other. The terminal device may be sometimes referred to as user equipment (UE). The terminal device may be any type of mobile terminal, fixed terminal, or portable terminal. The terminal device may be various wireless communication devices that have a wireless communication function. With emergence of an Internet of Things (IOT) technology, increasingly more devices that previously have no communication function, for example, but not limited to, a household appliance, a transportation tool, a tool device, a service device, and a service facility, start to obtain a wireless communication function by being configured with a wireless communication unit, so as to access a wireless communication network and accept remote control. Such a device has the wireless communication function because the device is configured with the wireless communication unit, and therefore also belongs to a scope of a wireless communication device. For example, the terminal device may include a mobile cellular phone, a cordless phone, a mobile terminal (MT), a mobile station, a mobile device, a wireless terminal, a handheld device, a client, a subscription station, a portable subscription station, an Internet node, a communicator, a desktop computer, a laptop computer, a notebook computer, a tablet computer, a personal communication system device, a personal navigation device, a personal digital assistant (PDA), a wireless data card, a wireless modulator demodulator (Modem), a positioning device, a radio broadcast receiver, an e-book device, a game device, an Internet of Things (IoT) device, a vehicle-mounted device, an aircraft, a virtual reality (VR) device, an augmented reality (AR) device, a wearable device (for example, a smart watch), a terminal device in a 5G network or any terminal device in an evolved public land mobile network (PLMN), another device that can be used for communication, or any combination thereof. This is not limited in embodiments of this disclosure.

The term “network node” or “network device” used in this disclosure is an entity or a node that may be configured to communicate with a terminal device, for example, may be an access network device. The access network device may be an apparatus that is deployed in a radio access network and that provides a wireless communication function for a mobile terminal. For example, the access network device may be a radio access network (RAN) network device. The access network device may include various types of base stations. The base station is configured to provide a radio access service for the terminal device. Specifically, each base station corresponds to a service coverage region, and a terminal device entering the region may communicate with the base station by using a radio signal, to receive the radio access service provided by the base station. The service coverage regions of base stations may overlap, and a terminal device in an overlapping region may receive radio signals from a plurality of base stations. Therefore, the plurality of base stations may simultaneously provide services for the terminal device. Based on a size of the provided service coverage region, the access network device may include a macro base station providing a macro cell, a micro base station providing a micro cell, a pico base station providing a pico cell, and a femto base station providing a femto cell. In addition, the access network device may further include various forms of relay stations, access points, remote radio units (RRU), radio heads (RH), remote radio heads (RRH), and the like. In systems using different radio access technologies, the access network device may have different names. For example, the access network device is referred to as an evolved NodeB (eNB or eNodeB) in a long term evolution (LTE) system network, is referred to as a NodeB (NB) in a 3G network, may be referred to as a gNodeB (gNB) or an NR NodeB (NR NB) in a 5G network, or the like. In some scenarios, the access network device may include a central unit (CU) and/or a distributed unit (DU). The CU and the DU may be deployed in different places. For example, the DU is remotely deployed in a high-traffic region, and the CU is deployed in a central equipment room. Alternatively, the CU and the DU may be deployed in a same equipment room. The CU and the DU may alternatively be different components in a rack. For ease of description, in subsequent embodiments of this disclosure, the foregoing apparatuses that provide a wireless communication function for the mobile terminal are collectively referred to as a network device. The apparatus may alternatively be a chip or a module that is in the mobile terminal or the access network device and that implements a related wireless communication function. This is not specifically limited in embodiments of this disclosure.

In a multi-device joint sensing scenario, point cloud information sensed by terminal devices from a plurality of angles and locations all needs to be sent to a base station for information fusion. Point cloud data exchanged between a device and a central node occupies a large quantity of air interface communication resources. Therefore, a more efficient point cloud compression and transmission method needs to be proposed. In embodiments of this disclosure, a geometric plane structure included in the point cloud data is fully explored, and a point cloud compression solution assisted by a geometric structure and a topological feature is proposed. To make objectives, the technical solutions, and advantages of this disclosure clearer, the following further describes this disclosure in detail with reference to the accompanying drawings. Specific operation methods, function descriptions, and the like in method embodiments may also be applied to apparatus embodiments or system embodiments.

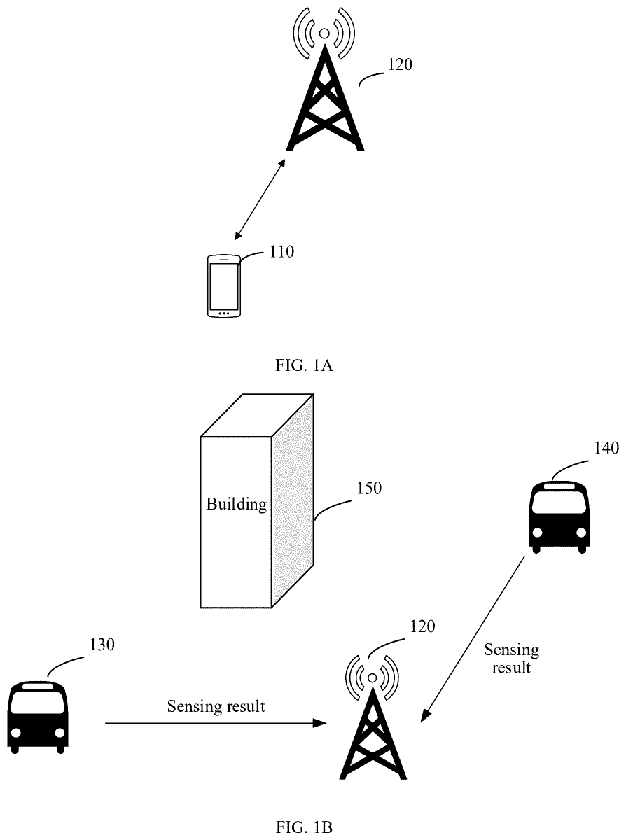

As shown in FIG. 1A, the system 100 includes a terminal device 110 and a network device 120. The terminal device 110 may communicate with the network device 120. For example, the terminal device 110 may compress sensed point cloud data, and send the compressed point cloud data to the network device 120. The network device 120 may be a network device in various network systems. For example, the network device 120 may be any device having a wireless transceiver function. The network device 120 includes but is not limited to: a conventional macro base station eNB (evolved NodeB) in a conventional UMTS/LTE (Universal Mobile Telecommunications system/long term evolution) wireless communication system, a micro base station eNB in a HetNet (heterogeneous network) scenario, a baseband processing unit BBU (baseband unit) and a remote radio unit RRU (remote radio unit) in a distributed base station scenario, a baseband pool BBU pool and a remote radio unit RRU in a CRAN (cloud radio access network) scenario, a gNB in a future wireless communication system, a subsequently evolved base station in 3GPP, an access node in a Wi-Fi system, a wireless relay node, a wireless backhaul node, and the like. The base station may be a macro base station, a micro base station, a pico base station, a small cell, a relay station, a balloon station, or the like. The network device 120 may alternatively be a server, a wearable device, a vehicle-mounted device, or the like. The terminal device 110 may alternatively be various user communication devices, for example, may be a vehicle-mounted communication module or another embedded communication module, a mobile phone, a tablet computer (Pad), a computer having a wireless transceiver function, a virtual reality (VR) terminal device, an augmented reality (AR) terminal device, a wireless terminal in industrial control, a tactile terminal device, a vehicle-mounted terminal device, a wireless terminal in self-driving, a wireless terminal in remote medical, a wireless terminal in a smart grid, a wireless terminal in transportation safety, a wireless terminal in a smart city, a wireless terminal in a smart home, a wearable terminal device, or the like.

FIG. 1B is a diagram of a point cloud data compression scenario according to some embodiments of this disclosure. As shown in FIG. 1B, point cloud data in an outdoor communication sensing scenario is generally generated by a building having a simple geometric plane feature, and the data itself usually presents a distinct geometric feature, which may be used to assist in point cloud data compression. In FIG. 1B, vehicle-mounted terminal devices 130 and 140 may be used as examples of the terminal device 110, and the network device 120 may be a base station. In this example, a plurality of devices (for example, two vehicle-mounted terminal devices 130 and 140 shown in FIG. 1B) jointly sense an ambient environment from different angles and at different locations, for example, sense a point cloud of a building 150, to obtain original point cloud data.

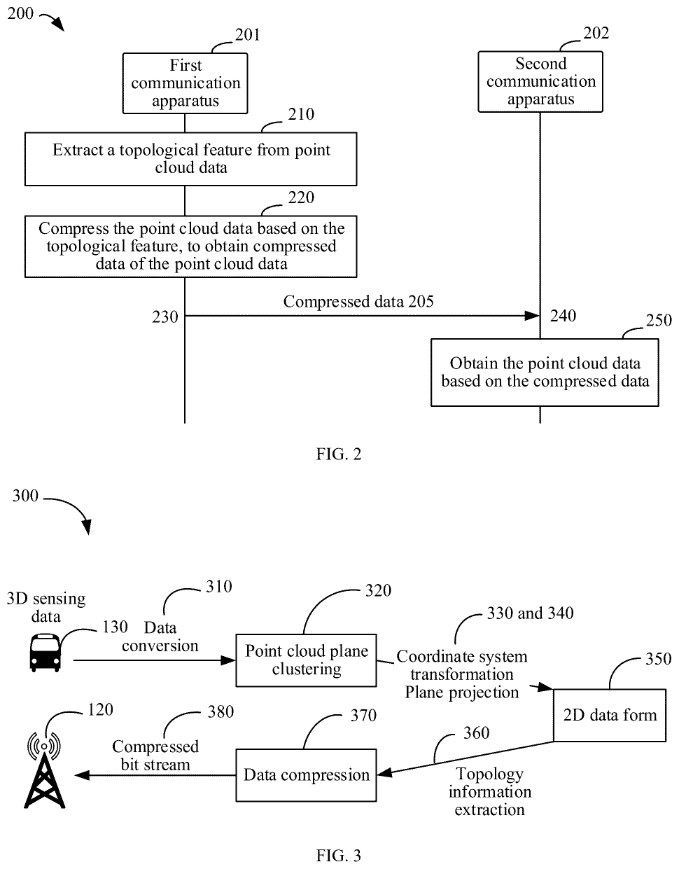

FIG. 2 is a diagram of a communication procedure according to some embodiments of this disclosure. In embodiments of this disclosure, a first communication apparatus 201 may be, for example, the terminal device 110, and a second communication apparatus 202 may be, for example, the network device 120. As shown in FIG. 2, in the procedure 200, at the first communication apparatus 201, a topological feature is extracted (210) from point cloud data. In some embodiments, the point cloud data may correspond to one clustering plane, that is, point cloud data obtained by clustering an input point cloud data set, and each type of clustered point cloud data corresponds to one clustering plane.

To achieve a better clustering effect, in the solution of this embodiment of this disclosure, a clustering plane is first determined. Specifically, the first communication apparatus 201 may separately project the input point cloud data set based on planes of a three-dimensional coordinate system, obtain a projected convex hull point set based on edge information of projections of the point cloud data in the planes of the three-dimensional coordinate system, and determine the clustering plane based on candidate planes including a plurality of points in the projected convex hull point set. In some examples, in a process of determining the clustering plane based on the candidate planes including the plurality of points in the projected convex hull point set, the first communication apparatus 201 may select, based on distribution of the input point cloud data set in the candidate planes, one or more candidate planes from the plurality of candidate planes including the plurality of points in the projected convex hull point set as the clustering plane.

In a clustering process, the first communication apparatus 201 may cluster the input point cloud data set based on distances from points, in a point cloud, corresponding to data in the input point cloud data set to one or more clustering planes, to obtain the point cloud data corresponding to the clustering plane, where the clustering plane corresponding to the point cloud data is a clustering plane with a shortest distance in the one or more clustering planes.

After completing the clustering, the first communication apparatus 201 may send, to the second communication apparatus 202, a clustering configuration for clustering the input point cloud data set, so that the second communication apparatus 202 restores original point cloud data from the clustered point cloud data based on the clustering configuration. A location of the original point cloud data corresponding to the first communication apparatus 201 is the input point cloud data set.

Refer to FIG. 2. The following first describes a specific implementation process of extracting a topological feature. The first communication apparatus 201 may obtain persistent homology of values of the point cloud data, and obtain first value information based on values that are of the point cloud data and whose persistent homology meets a preset condition, where the first value information is used to express the topological feature. To obtain the persistent homology of the values of the point cloud data, the first communication apparatus 201 may generate a persistent diagram based on the point cloud data. The persistent diagram may be used to analyze the persistent homology of the values of the point cloud data. Therefore, the first communication apparatus 201 may select, based on the persistent diagram, the values that are of the point cloud data and whose persistent homology meets the preset condition, to obtain the first value information. In some embodiments, the first value information is associated with a first part of the point cloud data.

To obtain the persistent homology, the first communication apparatus 201 may convert the point cloud data into a two-dimensional point cloud matrix, where elements in the two-dimensional point cloud matrix correspond to the values of the point cloud data. The first communication apparatus 201 obtains the persistent homology based on element values and element locations in the two-dimensional point cloud matrix. For example, by using the foregoing method, the point cloud data may be first converted into a two-dimensional point cloud matrix, then a persistent diagram is generated based on element values and element locations in the two-dimensional point cloud matrix, and the persistent homology is obtained by using the persistent diagram. In some embodiments, the first communication apparatus 201 may first generate a point cloud data vector based on the element values and the element locations in the two-dimensional point cloud matrix, and then obtain the persistent homology based on the values of the point cloud data and locations corresponding to the values of the point cloud data in the point cloud data vector. For example, a persistent diagram may be generated by using the foregoing steps, and then the persistent diagram is used to obtain the persistent homology.

In some embodiments, a manner of generating the point cloud data vector may be: generating the point cloud data vector based on an arrangement order, indicated in a coordinate indication mode configuration, of the values of the point cloud data in the two-dimensional point cloud matrix.

In some examples, the arrangement order of the values of the point cloud data in the two-dimensional point cloud matrix may be indicated by using a coordinate indication mode configuration indication. In other words, the coordinate indication mode configuration may indicate the arrangement order that is of the values of the point cloud data and that is used when the two-dimensional point cloud matrix is used to generate the point cloud data vector. For example, elements in rows and columns in the two-dimensional point cloud matrix are arranged in a vertical, horizontal, or zigzag manner, to obtain the point cloud data vector. In some embodiments, the first communication apparatus 201 may obtain a preset coordinate indication mode configuration, or generate the coordinate indication mode configuration and send the coordinate indication mode configuration, or receive the coordinate indication mode configuration. Specifically, in some examples, the coordinate indication mode configuration is preset in a protocol, that is, is preset. Both the first communication apparatus 201 and the second communication apparatus 202 know the preset coordinate indication mode configuration, and the preset coordinate indication mode configuration may be obtained when needing to be used. In some other examples, the coordinate indication mode configuration may be generated by the first communication apparatus 201, and sent to the second communication apparatus 202. In still some other embodiments, the coordinate indication mode configuration may be generated by the second communication apparatus 202, and the first communication apparatus 201 may receive the coordinate indication mode configuration from the second communication apparatus 202.

The point cloud data may be located in a three-dimensional coordinate system before being converted into the two-dimensional point cloud matrix. The three-dimensional coordinate system may be converted into another three-dimensional coordinate system through coordinate system mapping. To distinguish between the two three-dimensional coordinate systems, the three-dimensional coordinate system on which coordinate system mapping is not performed herein may be referred to as a three-dimensional global coordinate system. The three-dimensional coordinate system after the mapping is referred to as a three-dimensional local coordinate system. In some examples, a coordinate system mapping operation may be performed in a process of converting the point cloud data into a two-dimensional point cloud matrix. Specifically, the first communication apparatus 201 may map the point cloud data from the three-dimensional global coordinate system to the three-dimensional local coordinate system, where a value range corresponding to the point cloud data on a Z axis in the three-dimensional local coordinate system is less than a value range corresponding to the point cloud on a Z axis in the three-dimensional global coordinate system, and then may convert the point cloud data in the three-dimensional local coordinate system into the two-dimensional point cloud matrix.

In some examples, whether to perform coordinate system mapping from the three-dimensional global coordinate system to the three-dimensional local coordinate system may be indicated by a conversion mode configuration. For example, if the conversion mode configuration indicates that the coordinate system mapping needs to be performed, an operation of mapping the point cloud data from the three-dimensional global coordinate system to the three-dimensional local coordinate system is performed; or if the conversion mode configuration indicates that the coordinate system mapping does not need to be performed, the operation is not performed. The conversion mode configuration may be generated by the first communication apparatus 201, and sent to the second communication apparatus 202, so that the second communication apparatus 202 can receive the conversion mode configuration. Alternatively, the conversion mode configuration may be generated by the second communication apparatus 202, and the conversion mode configuration may be sent by the second communication apparatus 202 and received by the first communication apparatus 201 from the second communication apparatus 202. In an example in which coordinate system mapping is performed, the first communication apparatus 201 may send a central point and information about at least two coordinate axes of the three-dimensional local coordinate system to the second communication apparatus 202. In some embodiments, the conversion mode configuration may be preset, for example, be preset in a protocol.

The first communication apparatus 201 may convert the point cloud data in the three-dimensional local coordinate system into a two-dimensional point cloud matrix. Specifically, the first communication apparatus 201 may quantize, based on a quantization configuration, coordinate values of the point cloud data in the three-dimensional local coordinate system, and obtain the two-dimensional point cloud matrix based on the point cloud data whose coordinate values have been quantized. In these embodiments, the element values that are in the two-dimensional point cloud matrix and that correspond to the values of the point cloud data are quantized Z-axis coordinate values of the point cloud data in the three-dimensional local coordinate system. In some other embodiments, the foregoing coordinate system mapping may not be performed. In these embodiments, quantized Z-axis coordinate values of the point cloud data in the three-dimensional global coordinate system are the element values in the two-dimensional point cloud matrix.

The quantization configuration indicates a manner of quantizing the coordinate values of the point cloud data, and may be generated by the first communication apparatus 201. The first communication apparatus 201 may send the quantization configuration to the second communication apparatus 202, so that the second communication apparatus 202 may receive the quantization configuration. Alternatively, the quantization configuration may be generated by the second communication apparatus 202. The second communication apparatus 202 may send the quantization configuration to the first communication apparatus 201, and the first communication apparatus 201 may receive the quantization configuration from the second communication apparatus 202. Alternatively, the quantization configuration may be preset, for example, be preset in a protocol. Selecting the values that are of the point cloud data and whose persistent homology

meets the preset condition may include: receiving a topology information configuration, where the topology information configuration indicates a ratio at which the topological feature is retained, so that the first communication apparatus 201 may select, based on the ratio, a plurality of values with largest persistent homology that are in the values of the point cloud data and whose quantity of the values meets the ratio. In some embodiments, the first communication apparatus 201 may receive the topology information configuration from the second communication apparatus 202, and the topology information configuration is generated by the second communication apparatus 202 and sent to the first communication apparatus 201.

After extracting the topological feature in the foregoing manner, the first communication apparatus 201 may compress (220) the point cloud data based on the topological feature, to obtain compressed data 205 of the point cloud data.

In some embodiments, in a process of compressing the point cloud data, the first communication apparatus 201 may generate the compressed data 205 based on the first value information and first location vector information corresponding to the first value information, where the first location vector information includes indication information for a location corresponding to the first value information in the point cloud data.

In some other embodiments, the first value information is associated with the first part of the point cloud data, the compressed data 205 further includes second location vector information associated with a second part of the point cloud data, and the second location vector information includes indication information for a location, in the point cloud data, corresponding to second value information associated with the second part of the point cloud data. In the process of compressing the point cloud data, the first communication apparatus 201 may generate the compressed data 205 based on the first value information associated with the first part of the point cloud data, the first location vector information associated with the first part of the point cloud data, and the second location vector information associated with the second part of the point cloud data. Refer to the foregoing content. The first location vector information includes the indication information for the location corresponding to the first value information in the point cloud data, the second location vector information includes the indication information for the location corresponding to the second value information in the point cloud data. In some embodiments, the first part of the point cloud data and the second part of the point cloud data form the point cloud data.

As described above, the first communication apparatus 201 may generate the point cloud data vector based on the element values and the element locations in the two-dimensional point cloud matrix. In this example, the indication information in the first location vector information may indicate a corresponding location of the first value information in the point cloud data vector.

The first communication apparatus 201 sends the compressed data 205 obtained in the foregoing manner to the second communication apparatus 202.

In the foregoing interaction process between the first communication apparatus 201 and the second communication apparatus 202, in some embodiments, the first communication apparatus 201 may further obtain, generate, or receive one or more items of other configuration information, which are denoted as first configuration information. In some examples, the first communication apparatus 201 may generate the first configuration information, and send the generated first configuration information to the second communication apparatus 202. The first configuration information may be used to configure, for example, a compression manner configuration, indicating a manner of compressing the point cloud data; or an auxiliary information precision configuration, indicating a compression boundary for compressing the point cloud data, a quantity of bits of a mapping coordinate system, and the like. In some other examples, the first configuration information may be generated by the second communication apparatus 202. The second communication apparatus 202 sends the first configuration information to the first communication apparatus 201, and the first communication apparatus 201 receives the first configuration information from the second communication apparatus 202. In still some other examples, the first configuration information of the first communication apparatus 201 and the second communication apparatus 202 is obtained preset first configuration information, and the preset first configuration information is, for example, specified in a protocol.

The first communication apparatus 201 may output compressed data 205. For example, the first communication apparatus sends (230) the compressed data 205 to the second communication apparatus. At the second communication apparatus 202, the compressed data 205 of the point cloud data is received (240) from the first communication apparatus 201. The second communication apparatus 202 may obtain (250) the point cloud data based on the compressed data 205.

In some embodiments, the compressed data 205 includes the first value information and the first location vector information that are associated with the point cloud data. In such embodiments, step 250 may be implemented as follows: The second communication apparatus 202 obtains the point cloud data based on the first value information and the first location vector information.

In some other embodiments, the first value information and the first location vector information of the compressed data 205 are associated with the first part of the point cloud data, and the compressed data 205 further includes the second location vector information associated with the second part of the point cloud data. In other words, the compressed data 205 includes (i) the first value information and the first location vector information that are associated with the first part of the point cloud data, and (ii) the second location vector information associated with the second part of the point cloud data. In this embodiment, step 250 may be implemented as: obtaining the point cloud data based on the first value information, the first location vector information, the second value information, and the second location vector information. The second value information is associated with the second part of the point cloud data, and is determined based on the first value information, the first location vector information, and the second location vector information. In other words, based on the first value information, the first location vector information, and the second location vector information, the second communication apparatus 202 may determine (250) the second value information associated with the second part of the point cloud data.

To determine the second value information, the second communication apparatus 202 may generate a point cloud data vector based on the first value information and the first location vector information, generate a function curve based on the point cloud data vector, and determine the second value information in the function curve based on the second location vector information.

There may be a plurality of manners of determining the second value information. For example, the second value information may be determined in an interpolation manner. It should be noted that embodiments of this disclosure are not limited to the listed manner, and another proper manner may alternatively be used.

In a process of obtaining the point cloud data by the second communication apparatus 202, in some examples, the second communication apparatus 202 may determine, based on an arrangement order of the values of the point cloud data in the two-dimensional point cloud matrix in the point cloud data vector, a location set of the first value information and the second value information in the two-dimensional point cloud matrix, determine the two-dimensional point cloud matrix based on the location set, and then determine the point cloud data based on the element values and the element locations in the two-dimensional point cloud matrix. As described above, the arrangement order may be indicated in the coordinate indication mode configuration, and the coordinate indication mode configuration may be generated by the first communication apparatus 201 or the second communication apparatus 202, or may be preset in a protocol. Details are not described again.

In some examples, in the process of obtaining the point cloud data, the second communication apparatus 202 may first determine the point cloud data in the three-dimensional local coordinate system based on the element values and the element locations in the two-dimensional point cloud matrix, and then map the point cloud data in the three-dimensional local coordinate system to the three-dimensional global coordinate system. A value range corresponding to the point cloud data on the Z-axis in the three-dimensional local coordinate system is less than a corresponding value range on the Z-axis in the three-dimensional global coordinate system. Refer to the foregoing descriptions. At the first communication apparatus 201, if the conversion mode configuration indicates that the coordinate system mapping needs to be performed, the first communication apparatus 201 performs an operation of mapping the point cloud data from the three-dimensional global coordinate system to the three-dimensional local coordinate system; or if the conversion mode configuration indicates that the coordinate system mapping does not need to be performed, the operation of mapping the point cloud data to the three-dimensional local coordinate system is not performed. Correspondingly, at the second communication apparatus 202, when the conversion mode configuration indicates to perform coordinate system mapping, the point cloud data in the three-dimensional local coordinate system is mapped to the three-dimensional global coordinate system based on the central point and the information about at least two coordinate axes of the three-dimensional local coordinate system that are sent by the first communication apparatus 201. When the conversion mode configuration indicates not to perform coordinate system mapping, the second communication apparatus 202 does not perform the operation of mapping the point cloud data to the three-dimensional global coordinate system. In some embodiments in which coordinate system mapping is not performed, in the process of obtaining the point cloud data, the second communication apparatus 202 may determine the point cloud data in the three-dimensional coordinate system (refer to the three-dimensional global coordinate system herein) based on the element values and the element locations in the two-dimensional point cloud matrix, where the element values in the two-dimensional point cloud matrix are quantized Z-axis coordinate values of the point cloud data in the three-dimensional global coordinate system.

Refer to some examples described above. At the first communication apparatus 201, coordinate values of the point cloud data in the three-dimensional local coordinate system are quantized, and then the two-dimensional point cloud matrix is obtained based on the point cloud data whose coordinate values have been quantized. Correspondingly, a corresponding dequantization operation may be performed at the second communication apparatus 202, to restore two-dimensional point cloud data to three-dimensional point cloud data. For example, quantized coordinate values of the point cloud data may be determined based on the element values and the element locations that correspond to the values of the point cloud data and that are in the two-dimensional matrix, and then the quantized coordinate values are dequantized based on a quantization configuration, to determine the point cloud data. The quantized coordinate values, after being dequantized, correspond to the Z-axis coordinate values of the point cloud data in the three-dimensional local coordinate system. In some other examples, if coordinate system mapping is not performed at the first communication apparatus 201, the Z-axis coordinate values of the point cloud data in the three-dimensional global coordinate system are obtained through dequantization at the second communication apparatus.

In addition, in some examples, at the first communication apparatus 201, the point cloud data used in the operation of extracting the topological feature from the point cloud data may be clustered point cloud data corresponding to a clustering plane. In this case, at the second communication apparatus 202, the point cloud data obtained by the second communication apparatus 202 through the foregoing steps also correspondingly corresponds to the clustering plane. To obtain original point cloud data, the second communication apparatus 202 may receive, from the first communication apparatus 201, a clustering configuration for clustering an input point cloud data set. The clustering configuration is used by the second communication apparatus 202 to obtain the input point cloud data set, that is, the original point cloud data, based on point cloud data corresponding to each clustering plane.

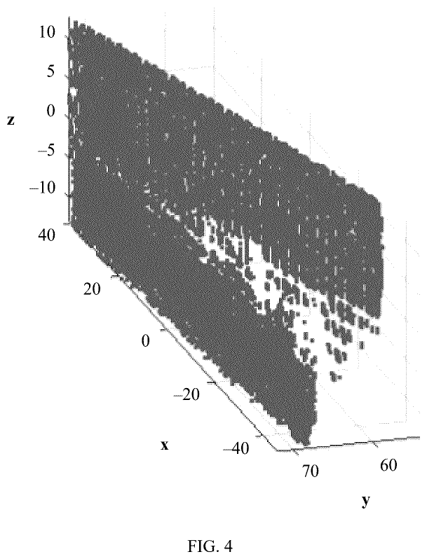

FIG. 3 is a diagram of a point cloud data compression procedure according to some embodiments of this disclosure. Because a topological feature cannot be directly extracted from a structure of a local point cloud, before topological feature filtering, segmentation and plane clustering need to be performed on an original point cloud by using an inherent geometric plane structure feature of a building that generates point cloud information. As shown in FIG. 3, geometric information of the point cloud is used as an auxiliary for performing plane clustering and coordinate system conversion on the point cloud data. Results of plane clustering are converted from 3D point cloud data plane projection into 2D data in a new local coordinate system. Parts representing important topology information are extracted from the 2D data for further compression. In this example, 3D sensing data may be 3D sensing data obtained by the vehicle-mounted terminal device 130. In the procedure 300, data conversion (310) is performed on the 3D (three-dimensional) sensing data, to perform point cloud plane clustering (320), that is, the point cloud data is clustered into point cloud data corresponding to a clustering plane. Using a plurality of clustering planes as an example, coordinate system transformation (330) may be performed on point cloud data corresponding to each clustering plane, that is, a global coordinate system in which the point cloud data is located is converted into a local coordinate system, to obtain point cloud data in the local coordinate system, and the point cloud data in the local coordinate system is projected (340) to a plane, to obtain (350) point cloud data in a 2D (two-dimensional) data form, for example, a two-dimensional point cloud information matrix. Topology information extraction (360) is performed on the point cloud data in the two-dimensional data form, to perform data compression (370). Information that expresses a topological feature and necessary location information need to be compressed and reported. In a data compression process, compressed information of the point cloud data, for example, a compressed bit stream, may be generated by using point cloud data that has topology information, related location information of the point cloud data, and location information of point cloud data that does not have topology information. The compressed bit stream is sent (380) to the network device 120 (for example, a base station). Data obtained through the topology information extraction may be divided into three parts: The first part is sparse matrix element values, which may be compressed by entropy coding, for example, arithmetic coding. The second part is location vectors corresponding to the element values of the first part. The third part is location vectors that are in the 2D data and that include a point cloud projection and do not belong to the second part. The location vectors of the second part and the third part may be differentiated, and then compressed by entropy coding.

Embodiments of this disclosure may be used in a future wireless communication system having a sensing function, for example, a next-generation cellular system or a short-range wireless communication system (for example, Wi-Fi or UWB), and may be widely applied to a terminal device 110 or a network device 120 in a future wireless communication scenario. Refer to FIG. 2 and FIG. 3. The following further describes a detailed procedure of the solutions in embodiments of this disclosure.

In step 1, point cloud data segmentation and plane clustering are performed based on a geometric feature. A building that generates point cloud data in a sensing scenario usually includes simple geometric planes. Any three non-collinear points may define a plane. Usually, only several points at an edge of a geometric plane need to be found to help locate the geometric plane in the point cloud data. These point clouds that depict geometric planes of the point cloud data form convex hulls (Convhull for short) of the point clouds of the geometric planes. Based on different angles, an element of a convex hull cannot be identified on a projection to a plane, and projections to an xy-plane, an xz-plane, and a yz-plane need to be performed separately and corresponding convex hulls need to be calculated.

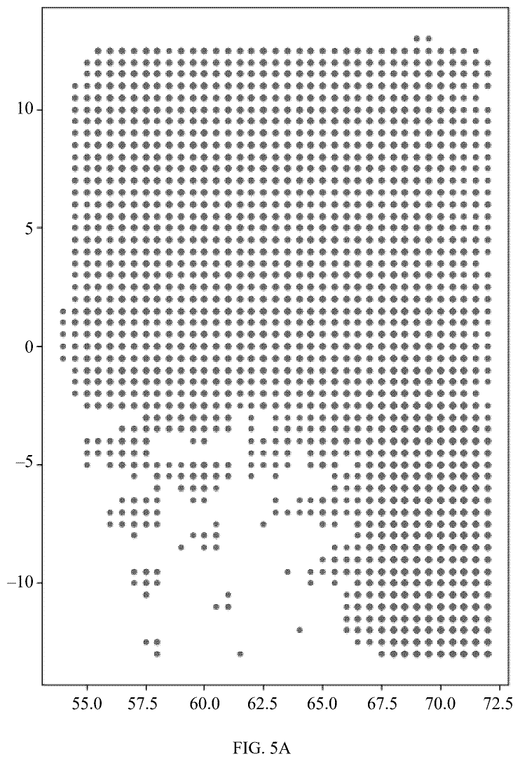

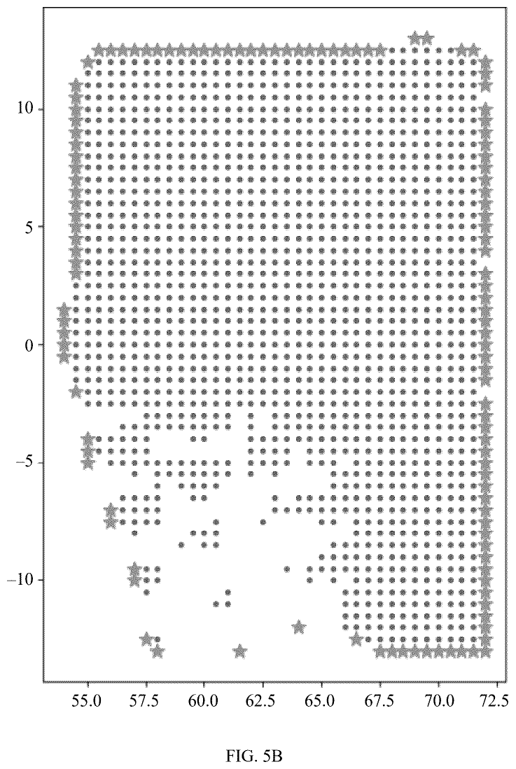

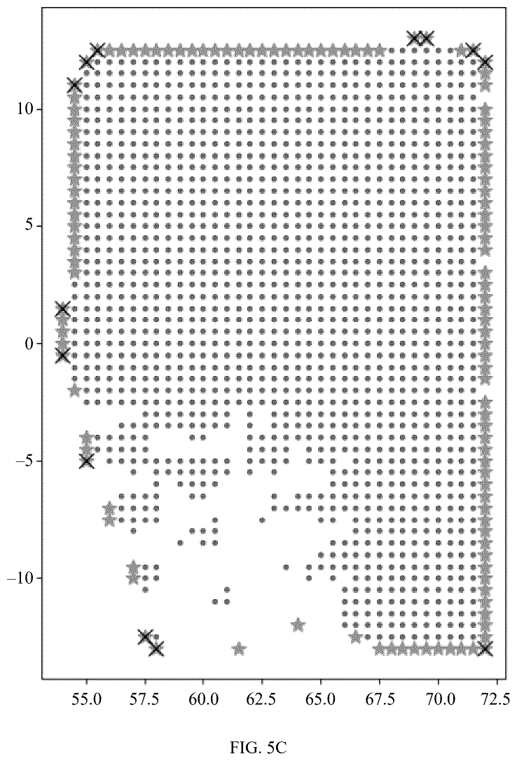

Specifically, an original point cloud is projected to the xy-plane, the xz-plane, and the yz-plane. A projection to a yz-plane is used as an example. FIG. 4 shows an original point cloud, and FIG. 5A shows a projection of the original point cloud to the yz-plane. Based on FIG. 5A, FIG. 5B further shows edge information of a projection plane, and the edge information is marked by a gray star “⋆”. Based on FIG. 5B, FIG. 5C further shows convex hulls of a projection plane, where the convex hull is marked by a black cross “×”. First, a projection to each plane is performed, to find edge information of a projection part, for example, a part marked by a gray star “⋆” in FIG. 5B or FIG. 5C. Then, a set of points that can represent projected convex hulls is calculated based on the edge information, for example, parts marked by black “×” in FIG. 5C. A convex hull S of the original point cloud is a convex hull set of projections to all planes. A candidate plane (that is, a candidate clustering plane) that can be used for clustering is selected from planes that can be represented by points in the convex hull set obtained through projection to the three planes. For example, a plane may be determined by using three points in the points of the convex hull set. If the three points are collinear points, a plane cannot be determined, and the three points cannot be used to determine the candidate plane. For another example, if two planes determined based on two groups of points are a same plane (or a difference between the two planes is small), the two planes may be considered as coplanar, and only one such plane needs to be retained. Some planes may be filtered out by using the foregoing standards, so as to preliminarily obtain a group of planes.

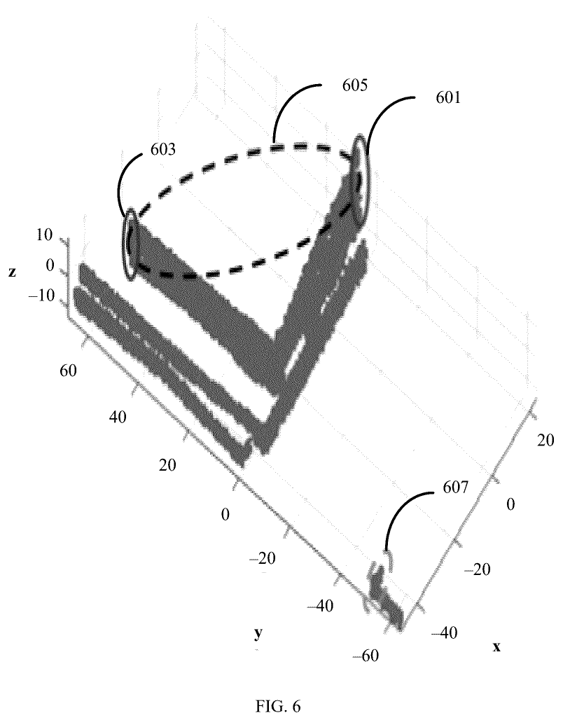

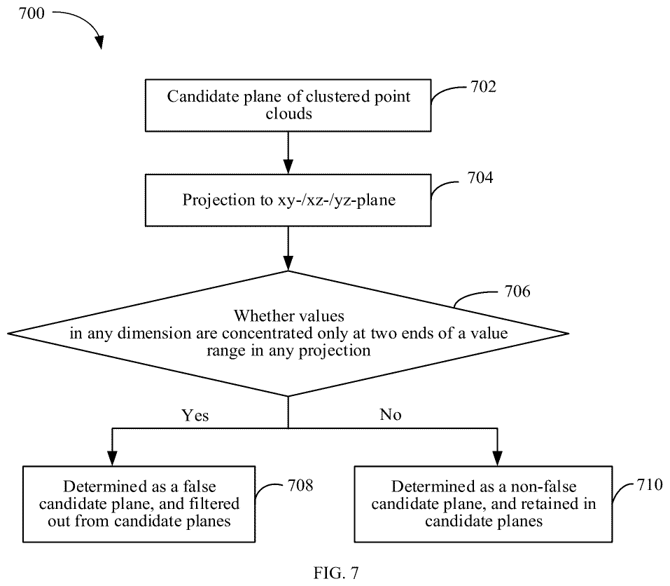

In some embodiments, because geometric plane structures that generate point cloud information have different sizes, a quantity of points clustered to the candidate plane cannot be used as a further filtering condition. In other words, the candidate plane (that is, the clustering plane) used for clustering cannot be effectively determined by using only the foregoing standards. In this case, some standards may be further set to determine the clustering plane. As shown in FIG. 6, points in a circle 601 and a circle 603 may be clustered to a clustering plane represented by a circle 605. In other words, a plane corresponding to the circle 605 may be determined based on the points in the circles 601 and 603. Based on a geometric structure of the original point cloud, a candidate plane represented by a circle 607 should be retained, and the candidate plane represented by the circle 605 should be filtered out. Because a geometric area that is of a correct candidate plane represented by the circle 607 and that generates point cloud information is small, a quantity of original point clouds distributed around a cluster of the circle 607 is small, and a quantity of point clouds on the candidate plane is less than a quantity of point clouds in the circles 601 and 603. A quantity of point clouds clustered to the candidate plane is used as a basis for determining whether to retain the candidate plane. The candidate plane corresponding to the circle 605 cannot be accurately filtered out on a premise of retaining the candidate plane corresponding to the circle 607, so that another criterion is needed to further refine candidate clustering planes, and a procedure of further filtering for the clustering plane is shown in FIG. 7. A candidate plane of clustered point clouds is obtained (702), the candidate plane of the clustered point clouds is projected to the xy-/xz-/yz-plane (704), and whether values in any dimension are concentrated only at two ends of a value range is determined (706) in any projection. For example, refer to FIG. 6. The point clouds in the circle 605 are distributed at two ends of the circle 605 (no point cloud is distributed in other parts of the circle 605), that is, a value range of the point clouds is located at two ends of a dimension in which the point clouds are located. Therefore, the candidate plane at the circle 605 is a false candidate plane and should be filtered out and not used as a clustering plane. That is, if a result of the foregoing determining is yes, the candidate plane is determined as a false candidate plane and is filtered out (708) from candidate planes; or if a result of the foregoing determining is no, the candidate plane is determined as a non-false plane and is retained (710) in candidate planes.

Some candidate planes are filtered out by using the method in the foregoing embodiment, and a finally retained candidate plane may be used as a clustering plane. A clustering method may be: clustering the point cloud data based on a nearest clustering plane, to obtain point cloud data corresponding to each corresponding clustering plane. Specifically, distances from the original point cloud to the candidate planes may be calculated. Point clouds are clustered to a nearest plane based on an order of the distances.

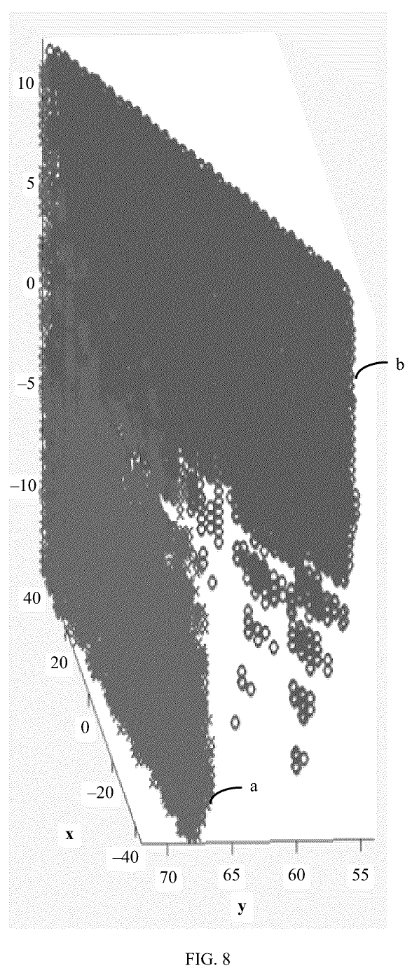

After the original point cloud data is segmented based on the geometric feature and the point cloud data is clustered in correspondence to the clustering plane, as shown in FIG. 8, clustered point cloud data (a point cloud data set a (which is a set of “×” in the figure) and a point cloud data set b (which is a set of “○” in the figure)) corresponding to two clustering planes are obtained through calculation, the terminal device 110 needs to dynamically report a clustering configuration obtained through point cloud segmentation to the base station. The clustering configuration may include c indicating a quantity of clusters of the point cloud data, and may further include information about a local coordinate system corresponding to each cluster, for example, information about a central point and two coordinate axes of the local coordinate system. The local coordinate system is obtained by performing coordinate system mapping (or referred to as coordinate system transformation) on a global coordinate system, and the local coordinate system is further described in step 2 below. The quantity of clusters of the point cloud data determines a quantity of local coordinate systems of mapped point clouds and a quantity of 2D matrices A in the following.

Point cloud data generated by several different planes may be segmented by using the foregoing step 1, so that a subsequent compression operation is performed on the clustered points in respective local coordinate systems.

In step 2, coordinate system transformation and 2D projection are performed on the clustered point cloud data. Specifically, for each cluster of clustered points of a plane (that is, clustered point cloud data corresponding to each clustering plane) obtained in step 1, the following operations are independently performed:

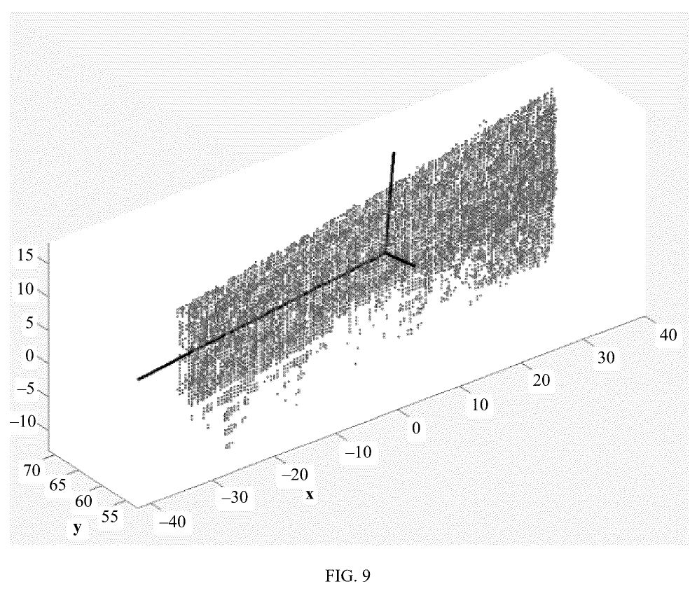

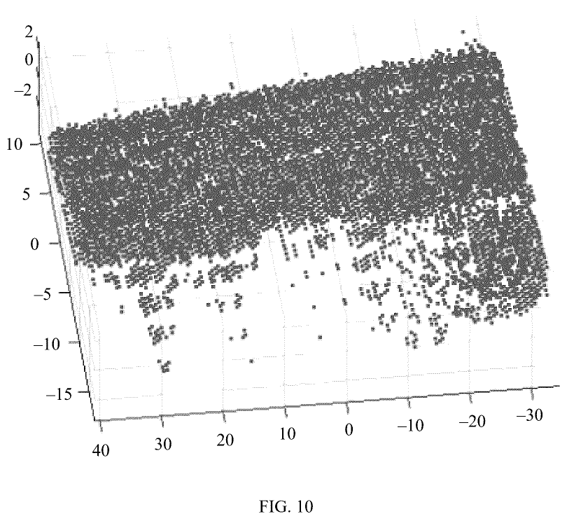

A new local coordinate system (or referred to as a local coordinate system) is obtained through calculation by using PCA (principal component analysis), and the terminal device 110 needs to report related information of the local coordinate system to the base station. Specifically, all point clouds clustered to the plane are mapped to the new coordinate system. FIG. 9 shows a clustering plane of an original point cloud and a global coordinate system of the clustering plane. FIG. 10 shows a new local coordinate system to which coordinate system mapping is performed. A value range of a z-axis in the new coordinate system (local coordinate system) is reduced, and the terminal device 110 needs to report, to the base station, at least information about a central point and at least two coordinate axes of the local coordinate system, for example, a location of the central point and vectors respectively corresponding to the at least two coordinate axes. By performing coordinate system mapping, mapping is performed from a global coordinate system to a local coordinate system, so that an error caused by quantization can be reduced, and subsequent compression work is facilitated.

Quantization is performed on x, y, and z axes in the new coordinate system separately, to store information about a 3D point cloud in a 2D matrix form (a matrix A), as shown in FIG. 11. Each element of the matrix A includes at most one point cloud obtained by quantizing the original point cloud, that is, a distance from a point to the clustering plane. The matrix A corresponds to a binary matrix B. For an element that does not include point cloud information in A, a value of B is 0; or for an element that includes point cloud information in A, a value of B is 1. In FIG. 11, a location of a black dot corresponds to an element whose value is 1 in the matrix B, and a white part corresponds to an element whose value is 0 in the matrix B.

In step 3, point filtering is performed based on topology information. For each clustering plane, based on a TSA (topological signal analysis) method, a topological feature and corresponding location information of point cloud data corresponding to the clustering plane are mainly extracted, to filter the point cloud data based on the topological feature, so as to extract representative Persistent Homology (PH, or referred to as homology persistence) as a topological feature of the data.

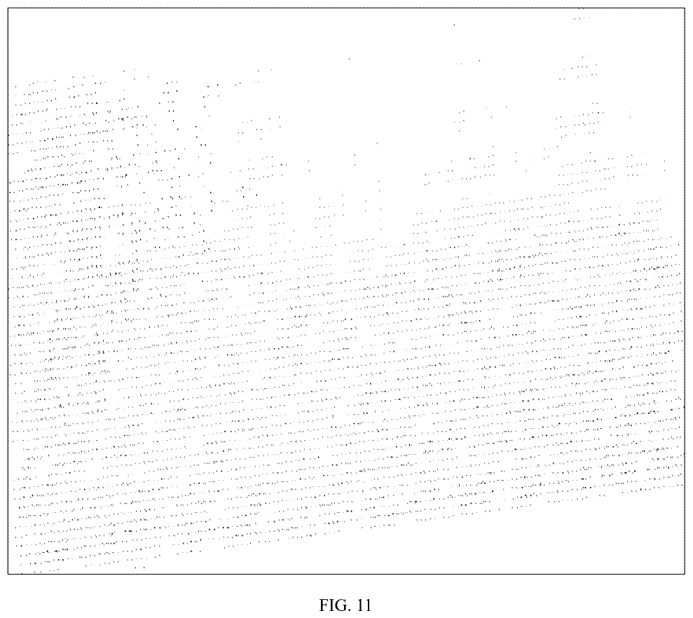

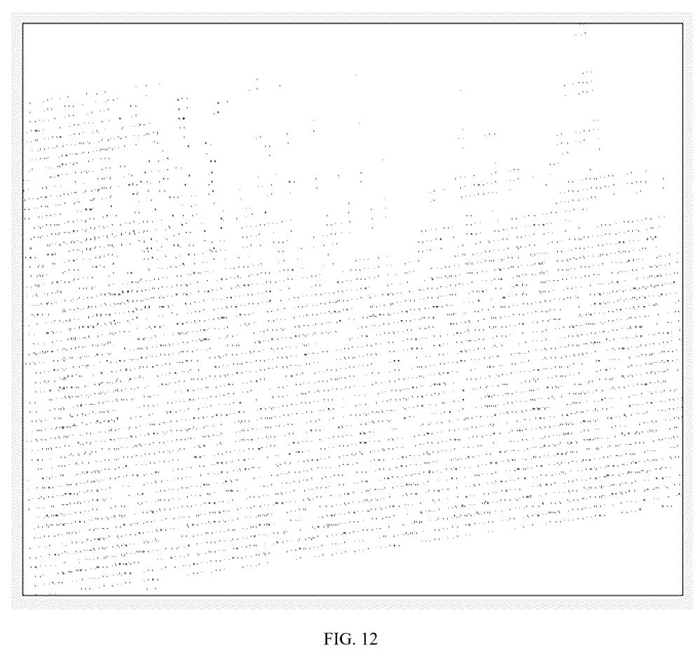

Specifically, topological feature extraction is first performed on the point cloud information included in the 2D matrix A in step 2. Location information that can express persistent homology that needs to be stored is selected from the matrix A, and is represented by a PD location indication set K. A corresponding matrix element value {A_{i,j}}_{i,j=1}^{n,m} (n and m may be calculated based on a quantization range and a quantization step) is extracted from the matrix A by using the set K, and is represented by using a PD information indication set {A(k)}_{k∈K}. The PD information indication set can express a topological feature of the matrix A. {A(k)}_{k∈K} and K are visualized as A^{ƒ}, as shown in FIG. 12. Location indication information of other non-zero elements in B is represented by a set K′, and K and K′ are complementary sets of each other relative to locations of the non-zero elements in B.

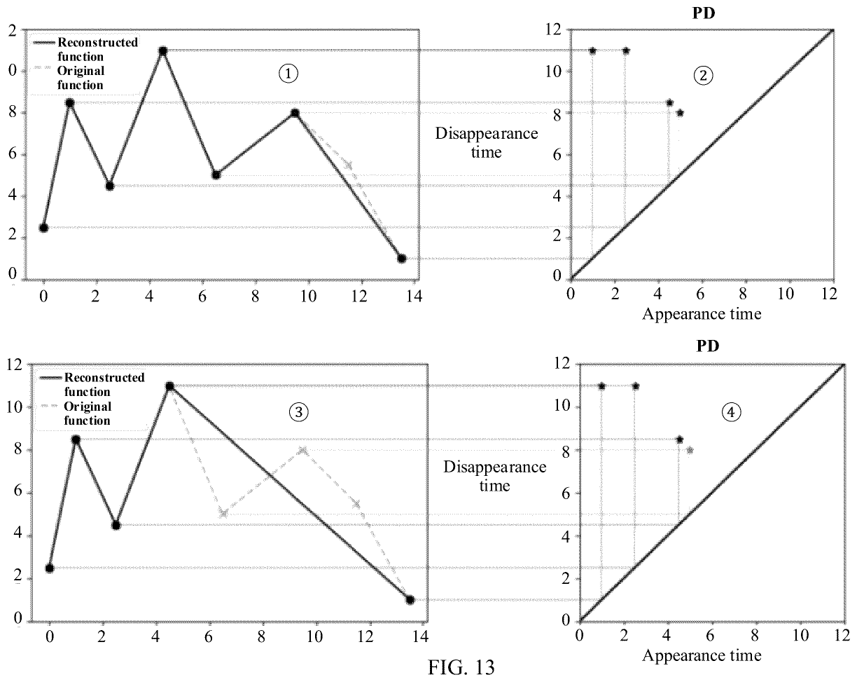

The following specifically describes how TSA extracts the topological feature of the data based on topology structure information expressed by a PD. The persistent homology is a simplicial complex constructed based on data, which depicts a geometric structure of high-dimensional data in topological space. For better visualization, in this embodiment, a simple one-dimensional function, like gray dashed lines in \textcircled{1} and \textcircled{3} in FIG. 13, is used to explain a process of extracting a topological feature by using a one-dimensional simplicial complex, that is, a line segment. It should be noted that, in FIG. 13, coinciding value points on the gray dashed line (corresponding to an original function) and a solid line (corresponding to a reconstructed function) are not shown because the dashed line is covered by the black solid line due to a color reason, but does not because the gray dashed line has no function values in these locations.

A persistent homology calculation result of the function in FIG. 13 (\textcircled{1}) is visualized as a PD (persistent diagram) in FIG. 13 (\textcircled{2}), and a persistent homology calculation result of the function in FIG. 13 (\textcircled{3}) is visualized as a PD in FIG. 13 (\textcircled{4}). The TSA filters the data based on the homology persistence, to select topology information (that is, the topological feature) that needs to be retained. A higher ratio at which the topological feature is retained indicates higher precision of the reconstructed function. Based on the topology information presented by the PD, when all topology structure information is retained, a function value unrelated to the PD may be filtered out, for example, “x” in the dashed line in FIG. 13 (\textcircled{1}). The function value is not reflected in information of the PD, indicating that the function value does not have any topology structure information. The reconstructed function in FIG. 13 (\textcircled{1}) is obtained by reconstructing, through interpolation, function values corresponding to locations of points represented by gray crosses “x” in FIG. 13 (\textcircled{1}) based on function values corresponding to complete persistent homology information in FIG. 13 (\textcircled{2}) and locations of the function values. Therefore, the reconstructed function (solid line) and the original function (dashed line) have the same topology information, as shown in FIG. 13 (\textcircled{2}). For a function value that has topology information and constitutes homology, for example, when only a part of persistent homology is retained, a homology feature with short persistence may be first filtered out. The reconstructed function corresponding to the black solid line in FIG. 13 (\textcircled{3}) is obtained by reconstructing, through interpolation, function values corresponding to locations of points represented by gray crosses “x” in FIG. 13 (\textcircled{3}) based on function values corresponding to persistent homology information of a black line in FIG. 13 (\textcircled{4}) and locations of the function values. Therefore, functions corresponding to black and gray in FIG. 13 (\textcircled{3}) have PDs that are partially the same, as shown in FIG. 13 (\textcircled{4}).

Longer existence time indicates more important homology. The persistence of the homology is a key condition for selecting a function value with a representative topological feature. Function values retained based on the persistent homology is a subset (topological feature values and locations thereof) of an original function, and a receive end reconstructs a complementary set (indicated by locations of remaining function values of the original function) of the subset in the original function by using the subset.

Based on the foregoing descriptions, in some embodiments, after plane clustering is performed on the original point cloud, the original point cloud is mapped to a new coordinate system corresponding to a clustering plane, so that a value range of a z-axis can be narrowed, and a quantization error can be reduced. After a 3D point cloud in the new coordinate system is converted into a data form of a 2D matrix, a key topological feature may be extracted based on the following steps:

The coordinate system is defined by coordinates of a central point (three real numbers) and two coordinate axis vectors (six real numbers). Specifically, one of two compression manners may be used: In one manner, scalar quantization is directly performed, and a quantity of quantized bits may be configured by the base station (dynamically indicated or statically configured), or the terminal device 110 determines precision by itself and dynamically reports the precision to the base station; and in the other manner, the coordinates of the central point and the coordinate axis vectors are represented by using a floating-point number (single-precision, double-precision, or half-precision).

A generated 2D matrix A (refer to FIG. 11) is very sparse due to a property of the point cloud. To avoid a communication resource waste caused by transmission of a complete matrix A, based on the TSA method described above, a topological feature is extracted based on a PD, to further compress the matrix A. (a) Points that express topology information are extracted from the matrix A, location information of the points is recorded, and the points are represented by using a PD location indication set K; (b) matrix element values {A_{i,j}}_{i,j=1}^{n,m} corresponding to the extracted location set K are represented by using a PD information indication set {A(k)}_{k∈K}; and (c) matrix element locations that are not selected in the matrix A but include 3D point cloud information are marked as a PD complementary set indication set K′ (a complementary set of the set K in locations of non-zero elements in a binary matrix B).

For 2D matrices A and A^{ƒ} before and after information filtering performed by the TSA based on the persistent homology, refer to FIG. 11 and FIG. 12 respectively. Point cloud information included in A^{ƒ} is a subset of A, and a terminal reports information about A^{ƒ} and the PD complementary set indication set K′ to the base station.

Data information related to A^{ƒ} may include: the PD location indication set K and the PD information indication set {A(k)}_{k∈K}.

A method for representing the location indication K and K′ is: marking based on a 2D coordinate indication mode. For example, when the 2D coordinate indication mode is vertical, k=n(j−1)+i∈K. In some embodiments, two bits may be used to represent the 2D coordinate indication mode: horizontal, vertical, or zigzag.

The terminal device 110 may dynamically report, to the base station, the PD location set that represents a topological feature, report the matrix element values corresponding to the set K, that is, the PD information indication set {A(k)}_{k∈K}, and further report the PD complementary set indication set K′. After obtaining the three parts of information (the PD location set

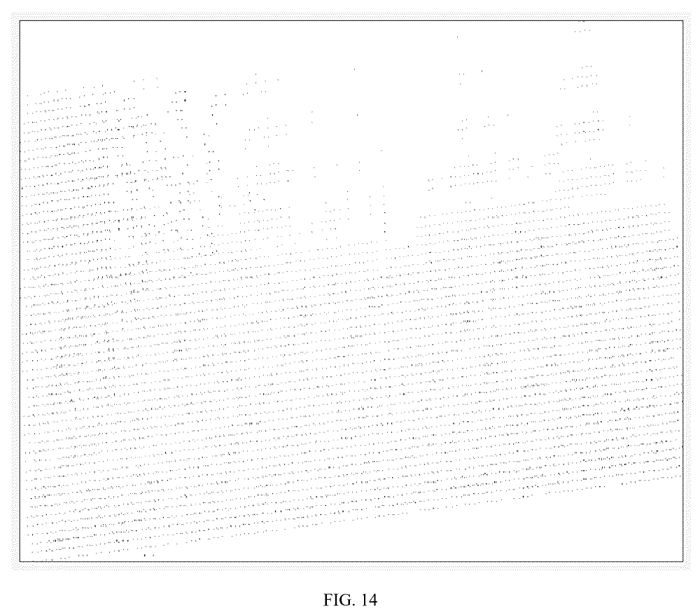

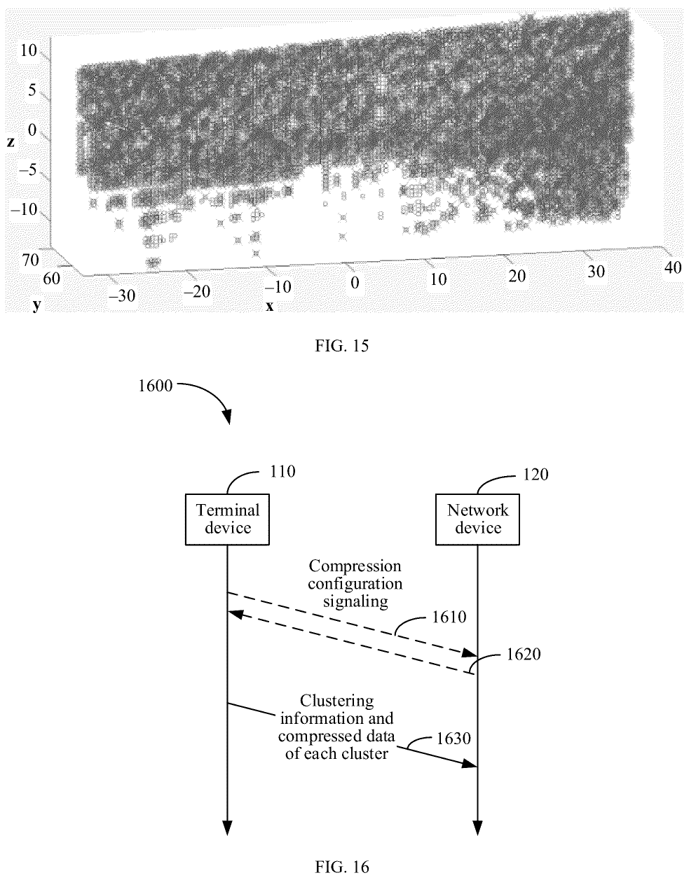

K, the PD information indication set {A(k)}_{k∈K}, and the PDcomplementary set indication set K′) sent by the terminal device 110 in step 3, the receive end (for example, the base station) reconstructs the matrix A in the 2D data form in step 2, and further restores the 3D point cloud data through dequantization based on information of the reconstructed matrix A. The following uses an example in which the receive end is a base station to describe a main procedure performed by the receive end. The base station may reconstruct element values at a location K′ in an interpolation manner. Then, the base station may determine, based on the location information indicated by K and K′, locations of corresponding rows and columns that are of the 3D point cloud data in the 2D matrix, and visualize a result into a 2D matrix Ã. As shown in FIG. 14, the base station restores, in an interpolation manner, information that constitutes the 2D matrix Ã from information that is sent by the terminal device 110 in step 3 and that is presented in A^{ƒ} The base station performs dequantization on the received and reconstructed element values based on the locations of the rows and the columns, to restore 3D point cloud data in the local coordinate system. Coordinate system mapping is performed on the 3D point cloud data in the local coordinate system, to obtain 3D point cloud data in the original global coordinate system. Comparison between the original point cloud and a restored point cloud is shown in FIG. 15, where the original point cloud is represented by a circle “○”, and the restored point cloud is represented by a cross “×”.

The following describes a resource scheduling and signaling transmission procedure for reporting point cloud data of a sensing device, for example, a device reporting criterion, a resource scheduling procedure, and a signaling indication procedure used in a cellular network.

Configuration agreement between the terminal device 110 and the base station may be indicated by the base station to the terminal device 110, or may be reported by the terminal device 110 to the base station. In a plurality of rounds of interaction between the terminal device 110 and the base station, a corresponding configuration may be sent in each round, or may be sent only in a specific round and a default configuration is used subsequently. Signaling transmission between the terminal device 110 and the base station may relate to a plurality of configurations, for example, a topology information configuration, a coordinate indication mode configuration, a quantization configuration, a conversion mode configuration, a compression manner configuration, an auxiliary information precision configuration, and the like. Signaling corresponding to the foregoing plurality of configurations may be collectively referred to as compression configuration signaling.

FIG. 16 is a diagram of a signaling transmission procedure according to some embodiments of this disclosure. An example in which the network device 120 in this embodiment is a base station is used for description. As shown in FIG. 16, in the procedure 1600, in some embodiments, the terminal device 110 may send (1610) compression configuration signaling to the base station. Alternatively, in some other embodiments, different from step 1610, the compression configuration signaling may be sent (1620) by the base station to the terminal device 110. In addition to exchanging the compression configuration signaling between the terminal device 110 and the base station, the terminal device 110 may further send (1630) clustering information and compressed data corresponding to each cluster to the base station. As an example, the compression configuration signaling includes signaling corresponding to the following configurations: a conversion mode configuration (1 bit), specifying whether to perform coordinate system mapping or not to perform coordinate system mapping; a 2D coordinate indication mode configuration (2 bits), for example, indicating to convert a 2D matrix into a one-dimensional vector in a vertical/horizontal/zigzag manner; a quantization manner configuration (1 bit), indicating to perform quantization in a uniform or non-uniform manner; a compression manner configuration (1 bit), indicating to perform compressing in an AC/NA (quantization only but not entropy coding) manner; an auxiliary information precision configuration, indicating a compression boundary and a quantity m of bits of a specified coordinate system; and a topology information configuration, which is a retained topological feature ratio r (only used for configuring the base station).

The clustering information and the compressed data that is of each cluster that are reported by the terminal device 110 to the base station include: a quantity c of clusters generated by original point cloud data; and compressed data related to each cluster. The compressed data related to each cluster includes coordinate information related to the conversion mode configuration. When coordinate system mapping is specified, information about a central point and two coordinate axes is sent. When coordinate system mapping is not specified, the coordinate information related to the conversion mode configuration is not sent. The compressed data related to each cluster may further include compressed information extracted based on TSA, including: a PD location indication set K, a PD information indication set {A(k)}_{k∈K}, and a PD complementary set indication set K′. If it is configured to perform quantization on a coordinate system, the compressed data related to each cluster may further specify the following information about x, y, and z axes in a new (original) coordinate system sequentially: a uniform (non-uniform) quantization parameter: a step s (a quantity I of quantization intervals and a step {sᵢ}ᵢ₌₁^{I} of each interval), and uniform (non-uniform) quantization boundary values: min and max ({minᵢ}ᵢ₌₁^{I} and {maxᵢ}ᵢ₌₁^{I} of each quantization interval).

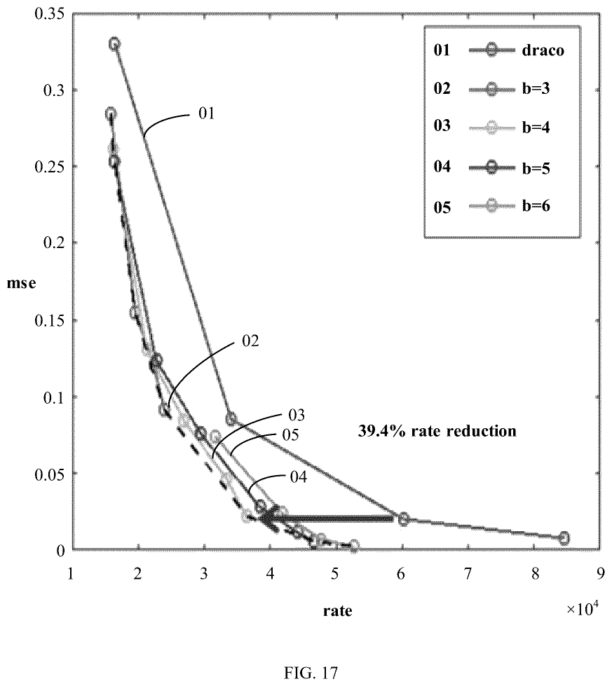

FIG. 17 is a diagram of comparison between simulation results and Draco according to some embodiments of this disclosure. Draco is a traditional open-source algorithm for compressing point cloud data. In a new coordinate system, in calculation of a 2D matrix A, quantization precision of an x-axis and a y-axis is 0.008, and a quantity of quantized bits of a z-axis ranges from 3 to 6. Specifically, as shown by values of b in FIG. 17, a curve corresponding to the value of b in Draco is a curve 01, and curves corresponding to different values of b in embodiments of this disclosure are curves 02, 03, 04, and 05. When the foregoing step 3 in embodiments of this disclosure is performed, only representative topology information is extracted, and a retaining ratio gradually increases. Values of the black dashed line are 0.001, 0.001, 0.001,0.005, 0.02, 0.03, 0.05, and 0.05 from left to right. A calculation method of mse in the figure is mse=max (mseₐ, mse_{b}), where mseₐ is mse from an original point cloud to a reconstructed point cloud, and mse_{b} is mse from the reconstructed point cloud to the original point cloud.

In embodiments of this disclosure, a geometric plane structure included in the point cloud data is fully explored, and a point cloud compression solution assisted by a geometric structure and a topological feature is proposed, to better compress point cloud data in a future sensing scenario, so that overall information of the point cloud data is transferred by using the topological feature of the point cloud data, thereby reducing a data amount reported by a terminal to a base station.

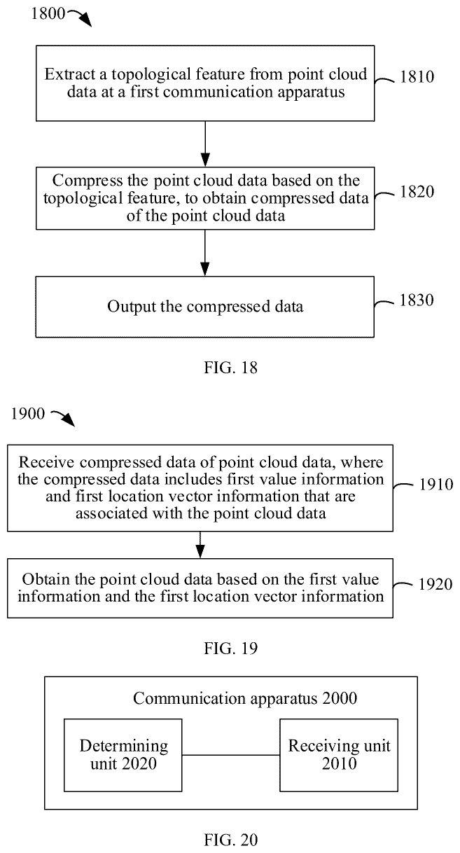

FIG. 18 is a diagram of a procedure implemented at a first communication apparatus according to some embodiments of this disclosure. As shown in FIG. 18, in the procedure 1800, in a block 1810, a topological feature is extracted from point cloud data at the first communication apparatus. In a block 1820, the point cloud data is compressed based on the topological feature, to obtain compressed data of the point cloud data. In a block 1830, the compressed data is output. The compressed data may be output in various manners. For example, in some examples, outputting the compressed data may be sending the compressed data to a second communication apparatus.

In some embodiments, extracting the topological feature from the point cloud data includes: obtaining persistent homology of values of the point cloud data; and obtaining first value information based on values that are of the point cloud data and whose persistent homology meets a preset condition, where the first value information is used to express the topological feature. In some embodiments, a persistent diagram may be generated based on the point cloud data, where the persistent diagram is used to obtain the persistent homology of the values of the point cloud data. Extracting the topological feature from the point cloud data includes: generating the persistent diagram based on the point cloud data; and selecting, based on the persistent diagram, the values that are of the point cloud data and whose persistent homology meets the preset condition, to obtain the first value information.

In some embodiments, compressing the point cloud data includes: generating the compressed data based on the first value information and first location vector information corresponding to the first value information, where the first location vector information includes indication information for a location corresponding to the first value information in the point cloud data. In some other embodiments, the first value information is associated with a first part of the point cloud data, the compressed data further includes second location vector information associated with a second part of the point cloud data, and the second location vector information includes indication information for a location, in the point cloud data, corresponding to second value information associated with the second part of the point cloud data. Compressing the point cloud data may include: generating the compressed data based on the first value information, the first location vector information associated with the first part of the point cloud data, and the second location vector information associated with the second part of the point cloud data. In some embodiments, the first part of the point cloud data and the second part of the point cloud data form the point cloud data.

In some embodiments, obtaining the persistent homology may include: converting the point cloud data into a two-dimensional point cloud matrix, where elements in the two-dimensional point cloud matrix correspond to the values of the point cloud data; and obtaining the persistent homology based on element values and element locations in the two-dimensional point cloud matrix.

To select the values that are of the point cloud data and whose persistent homology meets the preset condition, the first communication apparatus may receive a topology information configuration, where the topology information configuration indicates a ratio at which the topological feature is retained; and select, based on the ratio, a plurality of values with largest persistent homology that are in the values of the point cloud data and whose quantity of the values meets the ratio.

Obtaining the persistent homology may include: generating a point cloud data vector based on the element values and the element locations in the two-dimensional point cloud matrix; and obtaining the persistent homology based on the values of the point cloud data and locations corresponding to the values of the point cloud data in the point cloud data vector. In some examples, the indication information in the first location vector information indicates a corresponding location of the first value information in the point cloud data vector.

Generating the point cloud data vector may include: generating the point cloud data vector based on an arrangement order, indicated in a coordinate indication mode configuration, of the values of the point cloud data in the two-dimensional point cloud matrix.

In some embodiments, the first communication apparatus may further generate the coordinate indication mode configuration, and send the coordinate indication mode configuration, for example, send the coordinate indication mode configuration to the second communication apparatus. In some other embodiments, the first communication apparatus may receive the coordinate indication mode configuration, for example, receive the coordinate indication mode configuration from the second communication apparatus. In the foregoing embodiments, the coordinate indication mode configuration may indicate an arrangement order that is of the values of the point cloud data and that is used when the two-dimensional point cloud matrix is used to generate the point cloud data vector. In still some other embodiments, the first communication apparatus may obtain a preset coordinate indication mode configuration.

In some embodiments, the point cloud data may be located in a three-dimensional global coordinate system, and converting the point cloud data into the two-dimensional point cloud matrix may include: mapping the point cloud data from the three-dimensional global coordinate system to a three-dimensional local coordinate system, where a value range corresponding to the point cloud data on a Z axis in the three-dimensional local coordinate system is less than a value range corresponding to the point cloud data on a Z axis in the three-dimensional global coordinate system, and converting the point cloud data in the three-dimensional local coordinate system into the two-dimensional point cloud matrix. Converting the point cloud data in the three-dimensional local coordinate system into the two-dimensional point cloud matrix includes: quantizing, based on a quantization configuration, coordinate values of the point cloud data in the three-dimensional local coordinate system, and obtaining the two-dimensional point cloud matrix based on the point cloud data whose coordinate values have been quantized, where the element values that are in the two-dimensional point cloud matrix and that correspond to the values of the point cloud data are quantized Z-axis coordinate values of the point cloud data.

In some examples, the first communication apparatus may first generate the quantization configuration, and send the quantization configuration, for example, send the quantization configuration to the second communication apparatus. In some other examples, the first communication apparatus may receive the quantization configuration, for example, receive the quantization configuration from the second communication apparatus. The quantization configuration indicates a manner of quantizing the coordinate values of the point cloud data.

In some embodiments, the quantized Z-axis coordinate values of the point cloud data in a three-dimensional coordinate system are the element values in the two-dimensional point cloud matrix. For an example in which coordinate system mapping is performed, the three-dimensional coordinate system may be a three-dimensional local coordinate system. For an example in which coordinate system mapping is not performed, the three-dimensional coordinate system may be a three-dimensional global coordinate system.

In some embodiments, the first communication apparatus maps the point cloud data from a three-dimensional global coordinate system to a three-dimensional local coordinate system when a conversion mode configuration indicates to perform coordinate system mapping. The first communication apparatus may generate the conversion mode configuration, and send the conversion mode configuration, for example, send the conversion mode configuration to the second communication apparatus. Alternatively, the first communication apparatus may receive the conversion mode configuration, for example, receive the conversion mode configuration from the second communication apparatus. The conversion mode configuration indicates whether to perform coordinate system mapping from the three-dimensional global coordinate system to the three-dimensional local coordinate system on the point cloud data.

The first communication apparatus may further send information about a central point and at least two coordinate axes of the three-dimensional local coordinate system to the second communication apparatus.

The point cloud data may correspond to one clustering plane, and the first communication apparatus may cluster an input point cloud data set based on distances from points, in a point cloud, corresponding to data in the input point cloud data set to one or more clustering planes, to obtain the point cloud data corresponding to the clustering plane, where the clustering plane corresponding to the point cloud data is a clustering plane with a shortest distance in the one or more clustering planes. In addition, the first communication apparatus may further send (for example, to the second communication apparatus) a clustering configuration for clustering the input point cloud data set.

Determining the clustering plane may include: separately projecting the input point cloud data set based on planes of the three-dimensional coordinate system; obtaining a projected convex hull point set based on edge information of projections of the point cloud data in the planes of the three-dimensional coordinate system; and determining the clustering plane based on candidate planes including a plurality of points in the projected convex hull point set. In some examples, the first communication apparatus may determine the clustering plane in the following manner: selecting, based on distribution of the input point cloud data set in the candidate planes, one or more candidate planes from the plurality of candidate planes including the plurality of points in the projected convex hull point set as the clustering plane.

In some embodiments, the first communication apparatus may further generate first configuration information, and send the first configuration information, for example, send the first configuration information to the second communication apparatus. Alternatively, the first communication apparatus may receive (for example, from the second communication apparatus) first configuration information. The first configuration information is used to configure at least one of the following: a compression manner configuration, indicating a manner of compressing the point cloud data; or an auxiliary information precision configuration, indicating at least one of a compression boundary for compressing the point cloud data and a quantity of bits of a mapping coordinate system. Alternatively, the first communication apparatus may obtain preset first configuration information.

FIG. 19 is a diagram of a procedure implemented at a second communication apparatus according to some embodiments of this disclosure. As shown in FIG. 19, in the procedure 1900, in a block 1910, compressed data of point cloud data is received, where the compressed data includes first value information and first location vector information that are associated with the point cloud data. In a block 1920, the point cloud data is obtained based on the first value information and the first location vector information.

In some embodiments, the first value information and the first location vector information are associated with a first part of the point cloud data, the compressed data further includes second location vector information associated with a second part of the point cloud data, and obtaining the point cloud data may include: obtaining the point cloud data based on the first value information, the first location vector information, second value information, and the second location vector information, where the second value information is associated with the second part of the point cloud data, and is determined based on the first value information, the first location vector information, and the second location vector information.

To determine the second value information, the second communication apparatus may generate a point cloud data vector based on the first value information and the first location vector information, generate a function curve based on the point cloud data vector, and determine the second value information in the function curve based on the second location vector information. For example, the second value information is determined in an interpolation manner.

The second communication apparatus may obtain the point cloud data by using the following method: determining, based on an arrangement order of values of the point cloud data in a two-dimensional point cloud matrix in the point cloud data vector, a location set of the first value information and the second value information in the two-dimensional point cloud matrix, determining the two-dimensional point cloud matrix based on the location set, and determining the point cloud data based on element values and element locations in the two-dimensional point cloud matrix. In some examples, the arrangement order may be indicated by a coordinate indication mode configuration.

The second communication apparatus may further generate the coordinate indication mode configuration, and send the coordinate indication mode configuration, for example, send the coordinate indication mode configuration to a first communication apparatus. Alternatively, the second communication apparatus may receive (for example, from the first communication apparatus) the coordinate indication mode configuration. The coordinate indication mode configuration indicates an arrangement order that is of values of the point cloud data and that is used when the two-dimensional point cloud matrix is used to generate the point cloud data vector. Alternatively, the second communication apparatus may obtain a preset coordinate indication mode configuration.

In some embodiments, that the second communication apparatus obtains the point cloud data may include: determining the point cloud data in a three-dimensional coordinate system based on the element values and the element locations in the two-dimensional point cloud matrix, where the element values in the two-dimensional point cloud matrix are Z-axis coordinate values of quantized point cloud data in the three-dimensional coordinate system. In some examples, the three-dimensional coordinate system is a three-dimensional global coordinate system, and the first communication apparatus may obtain a preset conversion mode configuration, or generate the conversion mode configuration and send the conversion mode configuration, or receive the conversion mode configuration. The conversion mode configuration indicates whether coordinate system mapping from the three-dimensional global coordinate system to a three-dimensional local coordinate system is performed on the point cloud data.

In some examples, for an embodiment in which coordinate system mapping is performed, to obtain the point cloud data, the second communication apparatus may first determine the point cloud data in the three-dimensional local coordinate system based on the element values and the element locations in the two-dimensional point cloud matrix, and then map the point cloud data in the three-dimensional local coordinate system to the three-dimensional global coordinate system. A value range corresponding to the point cloud data on a Z-axis in the three-dimensional local coordinate system is less than a corresponding value range on a Z-axis in the three-dimensional global coordinate system.

In some embodiments, when a conversion mode configuration indicates to perform coordinate system mapping, the point cloud data in the three-dimensional local coordinate system may be mapped to the three-dimensional global coordinate system based on information that is about a central point and at least two coordinate axes of the three-dimensional local coordinate system and that is sent by the first communication apparatus. The second communication apparatus may generate the conversion mode configuration, and send the conversion mode configuration to the first communication apparatus. Alternatively, the second communication apparatus may receive the conversion mode configuration from the first communication apparatus. The foregoing conversion mode configuration indicates whether to perform coordinate system mapping.

In some embodiments, to obtain the point cloud data, the second communication apparatus may determine quantized coordinate values of the point cloud data based on the element values and the element locations that correspond to the values of the point cloud data and that are in the two-dimensional matrix, and then dequantize the quantized coordinate values based on a quantization configuration, to determine the point cloud data. In some examples, the second communication apparatus may generate the quantization configuration, and send the quantization configuration, for example, send the quantization configuration to the first communication apparatus. In some other examples, the second communication apparatus may receive the quantization configuration, for example, receive the quantization configuration from the first communication apparatus. In still some other examples, the second communication apparatus may obtain a preset quantization configuration. The quantization configuration indicates a manner of quantizing the coordinate values of the point cloud data. The quantized coordinate values, after being dequantized, correspond to the Z-axis coordinate values of the point cloud data in the three-dimensional coordinate system, for an embodiment in which coordinate system mapping is performed, the three-dimensional coordinate system is a three-dimensional local coordinate system, and for an embodiment in which coordinate system mapping is not performed, the three-dimensional coordinate system is a three-dimensional global coordinate system.

In some embodiments, the point cloud data may correspond to a clustering plane. The second communication apparatus may receive a clustering configuration for clustering an input point cloud data set, for example, receive the clustering configuration from the first communication apparatus. The clustering configuration is used by the second communication apparatus to obtain the input point cloud data set based on point cloud data corresponding to each clustering plane.

In some embodiments, the second communication apparatus may further generate first configuration information, and send the first configuration information, for example, send the first configuration information to the first communication apparatus. Alternatively, the second communication apparatus may receive first configuration information, for example, receive the first configuration information from the first communication apparatus. Alternatively, preset first configuration information is obtained from the first communication apparatus. The first configuration information is used to configure at least one of the following: a compression manner configuration, indicating a manner of compressing the point cloud data; or an auxiliary information precision configuration, indicating at least one of a compression boundary for compressing the point cloud data and a quantity of bits of a mapping coordinate system.

The second communication apparatus may further send a topology information configuration to the first communication apparatus, where the topology information configuration indicates a ratio at which a topological feature is retained, and the topological feature is used by the first communication apparatus to determine the first value information from the point cloud data.

FIG. 20 is a diagram of main composition of a possible communication apparatus according to an embodiment of this disclosure. The communication apparatus may implement functions of the first communication apparatus or the second communication apparatus in the foregoing method embodiments, and therefore can also achieve the beneficial effects of the foregoing method embodiments. In this embodiment of this disclosure, for the network device 120 shown in FIG. 1A as an example of the second communication apparatus, the communication apparatus may be, for example, the network device 120, or may be a module (for example, a chip) used in the network device 120.

An example in which the communication apparatus implements the functions of the second communication apparatus is used. As shown in FIG. 20, the communication apparatus 2000 includes a receiving unit 2010 and a determining unit 2020. The communication apparatus may be configured to implement the functions of the second communication apparatus in the method embodiment shown in FIG. 19. In some embodiments, the receiving unit 2010 may be a receiver.

When the communication apparatus 2000 is configured to implement the functions of the second communication apparatus in the method embodiment shown in FIG. 19, the receiving unit 2010 is configured to receive compressed data of point cloud data from the first communication apparatus, where the compressed data includes first value information and first location vector information that are associated with the point cloud data; and the determining unit 2020 is configured to obtain the point cloud data based on the first value information and the first location vector information.

A case in which the communication apparatus implements the functions of the first communication apparatus is similar to the foregoing descriptions, and is not described. In addition, for more detailed descriptions of the receiving unit 2010 and the determining unit 2020, refer to related descriptions in the foregoing method embodiments. Details are not described herein again.

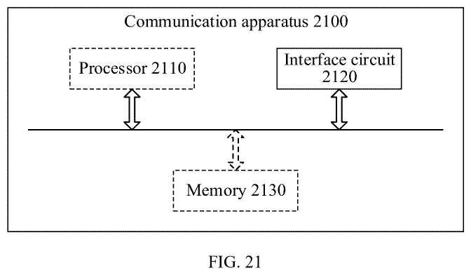

As shown in FIG. 21, the communication apparatus 2100 includes an interface circuit 2120. Optionally, a processor 2110 may be further included. The processor 2110 and the interface circuit 2120 are coupled to each other. It may be understood that the interface circuit 2120 may be a transceiver or an input/output interface. Optionally, the communication apparatus 2100 may further include a memory 2130, configured to: store instructions executed by the processor 2110, or store input data required by the processor 2110 to run the instructions, or store data generated after the processor 2110 runs the instructions.

When the communication apparatus 2100 is configured to implement the method in the method embodiment in FIG. 18, the interface circuit 2120 is configured to perform a function of a sending unit. When the communication apparatus 2100 is configured to implement the method in the method embodiment in FIG. 19, the interface circuit 2120 is configured to perform a function of the receiving unit 2010.

When the communication apparatus is a chip used in the terminal device 110, the chip in the terminal device implements a function of the terminal device 110 in embodiments of this disclosure. The chip in the terminal device receives information from another module (for example, a radio frequency module or an antenna) in the terminal device 110, where the information may be sent by another terminal device. Alternatively, the chip in the terminal device sends information to another module (for example, a radio frequency module or an antenna) in the terminal device 110, where the information is sent to another terminal device.

It may be understood that the processor in embodiments of this application may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any conventional processor.

An embodiment of this application provides a communication system. The communication system may include the communication apparatus in the embodiment shown in FIG. 20, for example, the terminal device 110 or the network device 120. Optionally, the terminal device 110 in the communication system may perform the communication method shown in FIG. 18. The network device 120 in the communication system may perform the communication method shown in FIG. 19. In some other embodiments, the communication system may include a communication apparatus 2100 that can perform the communication method shown in FIG. 20.

An embodiment of this disclosure further provides a circuit. The circuit may be coupled to a memory, and may be configured to perform a procedure related to the terminal device 110 or the network device 120 in any one of the foregoing method embodiments. A chip system may include a chip, and may further include another component, for example, a memory or a transceiver.

It should be understood that the processor mentioned in embodiments of this disclosure may be a CPU, or may be another general-purpose processor, a digital signal processor (DSP), an application-specific integrated circuit (ASIC), a field programmable gate array (FPGA) or another programmable logic device, a discrete gate or a transistor logic device, a discrete hardware component, or the like. The general-purpose processor may be a microprocessor, or the processor may be any conventional processor or the like.

It should be further understood that the memory mentioned in embodiments of this disclosure may be a volatile memory or a non-volatile memory, or may include both a volatile memory and a non-volatile memory. The non-volatile memory may be a read-only memory (ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (RAM), which is used as an external cache. Through example but not limitative description, many forms of RAMs may be used, for example, a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchronous link dynamic random access memory (synchlink DRAM, SLDRAM), and a direct rambus random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, the memory (a storage module) is integrated into the processor.

It should be noted that the memory described in this specification aims to include but is not limited to these memories and any memory of another proper type.

It should be understood that sequence numbers of the foregoing processes do not mean execution sequences in various embodiments of this disclosure. The execution sequences of the processes should be determined according to functions and internal logic of the processes, and should not be construed as any limitation to the implementation processes of embodiments of this disclosure.

A person of ordinary skill in the art may be aware that, in combination with the examples described in embodiments disclosed in this specification, modules and algorithm steps can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the system, apparatus, and module described above, refer to a corresponding process in the foregoing method embodiments, and details are not described herein again.

In the several embodiments provided in this disclosure, it should be understood that the disclosed communication method and apparatus may be implemented in other manners. For example, the foregoing described apparatus embodiments are merely examples. For example, division into the modules is merely logical function division and may be other division in actual implementation. For example, a plurality of modules or components may be combined or integrated into another system, or some features may be ignored or not performed. In addition, the displayed or described mutual couplings or direct couplings or communication connections may be implemented through some interfaces. The indirect couplings or communication connections between the apparatuses or units may be implemented in electronic, mechanical, or other forms.

The modules described as separate parts may or may not be physically separate, and parts displayed as modules may or may not be physical modules, may be located in one position, or may be distributed on a plurality of network units. Some or all of the units may be selected based on actual requirements to achieve the objectives of the solutions of embodiments.

In addition, functional modules in embodiments of this disclosure may be integrated into one processing module, or each of the modules may exist alone physically, or two or more modules may be integrated into one module.

When the functions are implemented in a form of a software functional module and sold or used as an independent product, the functions may be stored in a computer-readable storage medium. Based on such an understanding, the technical solutions of this disclosure essentially, or the part contributing to this disclosure, or some of the technical solutions may be embodied in a form of a software product. The computer software product is stored in a storage medium, and includes several instructions for instructing a computer device (which may be a personal computer, a server, the network device 120, or the like) to perform all or some of the steps in the methods in embodiments of this application. The computer-readable storage medium may be any usable medium that can be accessed by a computer. The following provides an example but does not impose a limitation: The computer-readable medium may include a random access memory (RAM), a read-only memory (ROM), an electrically erasable programmable read-only memory (EEPROM), a compact disc read-only memory (CD-ROM), a universal serial bus flash disk, a removable hard disk, or another optical disc storage or a magnetic disk storage medium, or another magnetic storage device, or any other medium that can carry or store expected program code in a form of an instruction or a data structure and can be accessed by a computer.

As used in this specification, the term “include” and similar terms should be understood as open inclusion, that is, “include but not limited to”. The term “based on” should be understood as “at least partially based on”. The term “an embodiment” or “this embodiment” should be understood as “at least one embodiment”. The terms “first”, “second”, and the like may refer to different objects or a same object, and are merely used to distinguish between specified objects, but do not imply a specific spatial order, a time order, an importance order, or the like of the specified objects. In some embodiments, a value, a process, a selected item, a determined item, a device, an apparatus, a means, a part, a component, or the like is referred to as “optimal”, “lowest”, “highest”, “minimum”, “maximum”, or the like. It should be understood that such a description is intended to indicate that a selection may be made among many available functional selections, and that such a selection does not need to be better, lower, higher, smaller, larger, or otherwise preferred than other selections in other aspects or in all aspects. As used in this specification, the term “determining” may cover a variety of actions. For example, “determining” may include operating, calculation, processing, exporting, investigating, looking up (for example, looking up in a table, a database, or another data structure), finding, and the like. In addition, “determining” may include receiving (for example, receiving information), accessing (for example, accessing data in a memory), and the like. In addition, “determining” may include parsing, selecting, choosing, establishing, and the like.

1. A communication method, comprising:
extracting a topological feature from point cloud data;
compressing the point cloud data based on the topological feature, to obtain compressed data of the point cloud data; and
outputting the compressed data.

2. The method according to claim 1, wherein the extracting the topological feature from the point cloud data comprises:
obtaining persistent homology of values of the point cloud data; and
obtaining first value information based on values of point cloud data whose persistent homology meets a preset condition, wherein the first value information is used to express the topological feature.

3. The method according to claim 2, the method further comprising:
generating a persistent diagram based on the point cloud data, wherein the persistent diagram is used to obtain the persistent homology of the values of the point cloud data.

4. The method according to claim 2, wherein the compressing the point cloud data comprises:
generating the compressed data based on the first value information and first location vector information corresponding to the first value information, wherein
the first location vector information comprises indication information for a location corresponding to the first value information in the point cloud data.

5. The method according to claim 4, wherein the first value information is associated with a first part of the point cloud data, the compressed data further comprises second location vector information associated with a second part of the point cloud data, and the second location vector information comprises indication information for a location, in the point cloud data, corresponding to second value information associated with the second part of the point cloud data.

6. The method according to claim 5, wherein the first part of the point cloud data and the second part of the point cloud data form the point cloud data.

7. The method according to claim 2, the method further comprising:
receiving a topology information configuration, wherein the topology information configuration indicates a ratio at which the topological feature is retained, the ratio is used for the values that are of the point cloud data whose persistent homology meets a preset condition.

8. The method according to claim 2, wherein the obtaining the persistent homology comprises:
converting the point cloud data into a two-dimensional point cloud matrix, wherein elements in the two-dimensional point cloud matrix correspond to the values of the point cloud data; and
obtaining the persistent homology based on element values and element locations in the two-dimensional point cloud matrix.

9. The method according to claim 8, wherein obtaining the persistent homology comprises:
generating a point cloud data vector based on the element values and the element locations in the two-dimensional point cloud matrix; and
obtaining the persistent homology based on the values of the point cloud data and corresponding locations of the values of the point cloud data in the point cloud data vector.

10. The method according to claim 9, wherein the indication information in the first location vector information indicates a corresponding location of the first value information in the point cloud data vector.

11. The method according to claim 9, further comprising one of the following:
obtaining a preset coordinate indication mode configuration;
generating the coordinate indication mode configuration, and sending the coordinate indication mode configuration; or
receiving the coordinate indication mode configuration, wherein
the coordinate indication mode configuration indicates an arrangement order that is of the values of the point cloud data and that is used when the two-dimensional point cloud matrix is used to generate the point cloud data vector.

12. A communication method, comprising:
receiving compressed data of point cloud data, wherein the compressed data comprises first value information and first location vector information that are associated with the point cloud data; and
obtaining the point cloud data based on the first value information and the first location vector information.

13. The method according to claim 12, wherein the first value information and the first location vector information are associated with a first part of the point cloud data, the compressed data further comprises second location vector information associated with a second part of the point cloud data, and obtaining the point cloud data comprises:
obtaining the point cloud data based on the first value information, the first location vector information, second value information, and the second location vector information, wherein the second value information is associated with the second part of the point cloud data, and is determined based on the first value information, the first location vector information, and the second location vector information.

14. The method according to claim 13, wherein the determining the second value information comprises:
generating a point cloud data vector based on the first value information and the first location vector information;
generating a function curve based on the point cloud data vector; and
determining the second value information in the function curve based on the second location vector information.

15. The method according to claim 14, wherein the obtaining the point cloud data comprises:
determining, based on an arrangement order of values of the point cloud data in a two-dimensional point cloud matrix in the point cloud data vector, a location set of the first value information and the second value information in the two-dimensional point cloud matrix;
determining the two-dimensional point cloud matrix based on the location set; and
determining the point cloud data based on element values and element locations in the two-dimensional point cloud matrix.

16. The method according to claim 15, further comprising one of the following:
obtaining a preset coordinate indication mode configuration;
generating the coordinate indication mode configuration, and sending the coordinate indication mode configuration; or
receiving the coordinate indication mode configuration, wherein
the coordinate indication mode configuration indicates the arrangement order of the values of the point cloud data in the two-dimensional point cloud matrix in the point cloud data vector.

17. A communication apparatus, comprising:
a processor; and
a memory storing a computer program code for execution by the processor, the computer program code comprising instructions for:
extracting a topological feature from point cloud data;
compressing the point cloud data based on the topological feature, to obtain compressed data of the point cloud data; and
outputting the compressed data.

18. The apparatus according to claim 17, wherein extracting the topological feature from the point cloud data comprises:
obtaining persistent homology of values of the point cloud data; and
obtaining first value information based on values that are of the point cloud data whose persistent homology meets a preset condition, wherein the first value information is used to express the topological feature.

19. The apparatus according to claim 18, wherein the computer program code comprising instructions for:
generating a persistent diagram based on the point cloud data, wherein the persistent diagram is used to obtain the persistent homology of the values of the point cloud data.

20. The apparatus according to claim 18, wherein the compressing the point cloud data comprises:
generating the compressed data based on the first value information and first location vector information corresponding to the first value information, wherein
the first location vector information comprises indication information for a location corresponding to the first value information in the point cloud data.
